(19) United States
(12) Patent Application Publication
(10) Pub. No.: US 2011/0038572 A1
(43) Pub. Date: Feb. 17, 2011

(54) Easy Open Package

(75) Inventor: Andrew W. Moehlenbrock, Simpsonville, SC (US)

Correspondence Address: LAW DEPARTMENT;SEALED AIR CORPORATION, P.O. BOX 464, DUNCAN, SC, 29334, US

(73) Assignee: CRYOVAC, INC., Duncan, SC (US)

(21) Appl. No.: 12/847,139

(22) Filed: Jul. 30, 2010

Related U.S. Application Data
(60) Provisional application No. 61/274,256, filed on Aug. 14, 2009.

(51) Int. Cl. B65D 33/18; B31B 1/90

(52) U.S. Cl. 383/211; 493/214

(57) ABSTRACT

An easy-open package includes a pouch including first and second side panels each having a first and second surface a first and second end, and a first and second transverse edge; a discrete strip, between the panels, including first and second surfaces each including a sealant, at least one of the surfaces including an easy-open sealant, the first surface of the strip sealed to the inner surface of the first panel, and the second surface of the strip sealed to the inner surface of the second panel; a first and second opening flap; and a product disposed in the pouch. Alternatively, an easy-open package includes a pouch including a folded web having first and second longitudinal edges, first and second transverse seals, a lap seal along the length of the folded web, a discrete strip within the lap seal, and a first opening flap; and a product disposed in the pouch.

This application claims the benefit of U.S. Provisional Application No. 61/274,256, filed Aug. 14, 2009, that application incorporated herein by reference in its entirety.

### FIELD OF THE INVENTION

This invention relates to an easy open package, and to methods of making the easy open package.

### BACKGROUND OF THE INVENTION

Food and non-food products, including produce, snack foods, cheese and the like have long been packaged in containers such as pouches, bags, or lidded trays or formed webs made from various thermoplastic materials such as polyethylene or polypropylene. These containers can be formed from a web or webs of thermoplastic material on packaging equipment, using various packaging processes, at a processing/packaging facility. Such equipment and processes includes horizontal form/fill/seal (HFFS), vertical form/fill/seal (VFFS), thermoforming/lidstock, and continuous horizontal packaging (sometimes referred to as Flow-wrap). In each case, the product is manually or automatically placed in a pouch, bag, formed web, tray, etc., the filled container is optionally vacuumized or gas flushed, and the mouth of the container is hermetically sealed to close and finish the package.

Opening of the finished package (i.e. opening with the use of tools such as scissors or knives) can provide access to the product by the consumer.

Common in the industry is the use of plastic zipper closures; press-to-close or slide zippers; interlocking closures; reclosable fasteners with interlockable fastener elements; interlocking rib and groove elements having male and female profiles; interlocking alternating hook-shaped closure members, and the like. These terms appear in the patent literature, and to some extent may overlap in meaning. These features may provide in some cases an easy-open feature to the package, and provide reclosability. However, such features are relatively expensive compared with the total cost of the packaging, and are not always easy to use.

There is need in the marketplace for a package, and methods of packaging that can be used in a manner that requires little or no modification to the packager's packaging equipment, while providing a manually (i.e. by hand, without the need for tools such as scissors or knives) openable feature, while maintaining hermeticity of the package when made, and without the use of plastic zipper closures; press-to-close or slide zippers; interlocking closures; reclosable fasteners with interlockable fastener elements; interlocking rib and groove elements having male and female profiles; interlocking alternating hook-shaped closure members, and the like.

Some retail packages currently do not offer an easy-open feature. Examples are some produce bags and snack food bags. In the produce market, there is a need for a cost-effective way to manually open retail produce bags, e.g. a package made in HFFS, VFFS, thermoforming/lidstock, or continuous horizontal packaging processes.

The present invention relates to a hermetically sealed package, and methods of making the package, which package is manually openable and adapted to package non-food and food products such as e.g. produce, snack foods, cheese, luncheon meat, sausage, culinary nuts, trail mix, etc. The package maintains a hermetic seal until the package is opened.

### SUMMARY OF THE INVENTION

### Statement of Invention/Embodiments of the Invention

In a first aspect, an easy-open package comprises:

a pouch comprising
a first and second side panel each comprising an outer and inner surface, a first and second side edge, and a first and second end, the first and second side panels joined together along their respective first and second side edges;
a first end defined by the first end of at least one of the first and second side panels respectively;
a second end defined by the second ends of the first and second side panels respectively;
the first and second side panels joined together along their respective second ends;
a discrete strip disposed between the first and second side panels, the discrete strip comprising a first and second surface, wherein
   the first and second surface each comprises a sealant,
   at least one of the first and second surfaces comprises an easy-open sealant,
   the first surface is sealed to the inner surface of the first side panel,
   the second surface is sealed to the inner surface of the second side panel, and
   the discrete strip is near and spaced apart from the first end of the pouch, and spaced apart from the second end of the pouch;
a first opening flap comprising a portion of the first side panel between the discrete strip and the first end of the first side panel, and
a second opening flap comprising a portion of the second side panel between the discrete strip and the first end of the second side panel; and
   a product disposed in the pouch.

Optionally, according to various embodiments of the first aspect of the invention:
the first and second side panels are joined together along their respective first and second side edges by a seal.
the first and second side panels are joined together along their respective first and second side edges by a fold.
the second end of the first side panel, and the second end of the second side panel, are joined together by a seal.
the second end of the first side panel, and the second end of the second side panel, are joined together by a fold.
the discrete strip is disposed perpendicular to the first and second side edges of the first and second side panel respectively.
the package is absent any zipper.
the package can be opened with a peel force of from 25 grams/inch to 5 pounds/inch.

In a second aspect, an easy-open package comprises:

a pouch comprising
a folded web having a first and second longitudinal edge, and an interior surface,
a first transverse seal at a first end of the folded web,
a second transverse seal at a second end of the folded web,
a lap seal extending along the length of the folded web,
a discrete strip comprising a first and second surface each comprising a sealant, at least one of the first and second surfaces comprising an easy-open sealant, the first and second surface of the discrete strip sealed to the interior surface of the folded web, and
a first opening flap defined by the first longitudinal edge of the folded web; and
   a product disposed in the pouch.

Optionally, according to various embodiments of the second aspect of the invention:
the package is absent any zipper.
the package can be opened with a peel force of from 25 grams/inch to 5 pounds/inch.

In a third aspect, a method of making an easy-open package in a horizontal form/fill/seal process comprises:
providing a lay-flat web;
providing a discrete strip comprising a first and second surface each comprising a sealant, at least one of the first and second surfaces comprising an easy-open sealant;
advancing the lay-flat web to a forming device to convert the lay-flat web to a folded web having an interior surface;
advancing the discrete strip such that when the package is made, the discrete strip is disposed between a first and second side panel of the package;
making side seals in the folded web to produce an open pouch comprising
   the first and second side panel each comprising an outer and inner surface, a first and second side edge, and a first and second end, the first and second side panels joined together along their respective first and second side edges by a seal,
   a first end defined by the first end of at least one of the first and second side panels respectively,
   a second end defined by the second ends of the first and second side panels respectively,
   the first and second side panels joined together along their respective second ends,
   the discrete strip near and spaced apart from the first end of the pouch, and spaced apart from the second end of the pouch,
   a first opening flap comprising a portion of the first side panel between the discrete strip and the first end of the first side panel, and
   a second opening flap comprising a portion of the second side panel between the discrete strip and the first end of the second side panel;
putting a product in the open pouch; and
sealing the first surface of the discrete strip to the inner surface of the first side panel, and sealing the second surface of the discrete strip to the inner surface of the second side panel, to close the pouch;
wherein the web is cut at the side seals during the step of making side seals in the folded web, or during or after any subsequent step, and
wherein at any time before or during the step of making side seals in the folded web, anchoring the discrete strip to the lay-flat web, interior surface of the folded web, or inner surface of the first or second side panel.

Optionally, according to various embodiments of the third aspect of the invention:
the discrete strip is advanced from a roll and applied to the lay-flat web prior to advancing the lay-flat web to the forming device.
the second end of the first side panel, and the second end of the second side panel, are joined together by a seal.
the second end of the first side panel, and the second end of the second side panel, are joined together by a fold.
the discrete strip is disposed perpendicular to the first and second side edges of the first and second side panel respectively.
the package is absent any zipper.
the package can be opened with a peel force of from 25 grams/inch to 5 pounds/inch.

In a fourth aspect, a method of making an easy-open package in a horizontal form/fill/seal process comprises:
providing a lay-flat web;
providing a discrete strip comprising a first and second surface each comprising a sealant, at least one of the first and second surfaces comprising an easy-open sealant, the discrete strip anchored to the lay-flat web;
advancing the lay-flat web with the discrete strip anchored thereto to a forming device to convert the lay-flat web to a folded web;
making side seals in the folded web to produce an open pouch comprising
   a first and second side panel each comprising an outer and inner surface, a first and second side edge, and a first and second end, the first and second side panels joined together along their respective first and second side edges by a seal,
   a first end defined by the first end of at least one of the first and second side panels respectively,
   a second end defined by the second ends of the first and second side panels respectively,
   the first and second side panels joined together along their respective second ends,
   the discrete strip near and spaced apart from the first end of the pouch, and
   spaced apart from the second end of the pouch,
   a first opening flap comprising a portion of the first side panel between the discrete strip and the first end of the first side panel, and
   a second opening flap comprising a portion of the second side panel between the discrete strip and the first end of the second side panel;
putting a product in the open pouch; and
sealing the first surface of the discrete strip to the inner surface of the first side panel, and sealing the second surface of the discrete strip to the inner surface of the second side panel, to close the pouch;
wherein the web is cut at the side seals during the step of making side seals in the folded web, or during or after any subsequent steps.

Optionally, according to various embodiments of the fourth aspect of the invention:
the second end of the first side panel, and the second end of the second side panel, are joined together by a seal.
the second end of the first side panel, and the second end of the second side panel, are joined together by a fold.
the discrete strip is disposed perpendicular to the first and second side edges of the first and second side panel respectively.
the package is absent any zipper.
the package can be opened with a peel force of from 25 grams/inch to 5 pounds/inch.

In a fifth aspect, a method of making an easy-open package in a horizontal form/fill/seal process comprises:
providing a lay-flat web;
providing a discrete strip comprising a first and second surface each comprising a sealant, at least one of the first and second surfaces comprising an easy-open sealant;
advancing the lay-flat web to a forming device to convert the lay-flat web to a folded web having an inner surface;
advancing the discrete strip such that when the package is made, the discrete strip is disposed between a first and second side panel of the package;
making side seals in the folded web to produce an open pouch comprising
   the first and second side panel each comprising an outer and inner surface, a first and second side edge, and a first and second end, the first and second side panels joined together along their respective first and second side edges by a seal,
   a first end defined by the first ends of the first and second side panels respectively,
   a second end defined by the second end of at least one of the first and second side panels respectively,
   the first and second side panels joined together along their respective first ends by a fold,
   the discrete strip near and spaced apart from the first end of the pouch, and spaced apart from the second end of the pouch,
   a first opening flap comprising a portion of the first side panel between the discrete strip and the first end of the first side panel, and
   a second opening flap comprising a portion of the second side panel between the discrete strip and the first end of the second side panel;
putting a product in the open pouch;
sealing the first surface of the discrete strip to the inner surface of the first side panel, and sealing the second surface of the discrete strip to the inner surface of the second side panel; and
sealing the inner surface of the first side panel to the inner surface of the second side panel to close the pouch;
wherein the web is cut at the side seals during the step of making side seals in the folded web, or during or after any subsequent step.

Optionally, according to various embodiments of the fifth aspect of the invention:
the discrete strip is advanced from a roll and anchored to the lay-flat web prior to advancing the lay-flat web to the forming device.

the discrete strip is disposed perpendicular to the first and second side edges of the first and second side panel respectively.

the package is absent any zipper.
the package can be opened with a peel force of from 25 grams/inch to 5 pounds/inch.

In a sixth aspect, a method of making an easy-open package in a vertical form/fill/seal process comprises:

providing a lay-flat web;
providing a discrete strip comprising a first and second surface each comprising a sealant, at least one of the first and second surfaces comprising an easy-open sealant;
advancing the lay-flat web over a forming device to convert the lay-flat web to a folded web having an interior surface;
advancing the discrete strip such that when the package is made, the discrete strip is disposed between a first and second side panel of the package;
making a longitudinal seal in the folded web;
transversely sealing the folded web to produce a first transverse seal in the folded web to define a first pouch having an interior surface, wherein the first transverse seal is a bottom trans-verse seal of the first pouch;
putting a product in the first pouch;
advancing the folded web, with the first pouch, downward a predetermined distance;
sealing the discrete strip to the interior surface of the first pouch to produce a top transverse seal in the first pouch;
sealing the folded web to produce a bottom transverse seal in a second pouch, the second pouch disposed above the first pouch, wherein the bottom transverse seal of the second pouch is disposed above, and spaced apart from, the top transverse seal of the first pouch; and
transversely cutting the folded web, at a line above and spaced apart from the top transverse seal of the first pouch, and below the bottom transverse seal of the second pouch, to separate the first pouch from the second pouch to make a package, the package comprising
the first and second side panel each comprising an outer and inner surface, a first and second side edge, and a first and second end, the first and second side panels joined together along their respective first and second side edges,
a first end defined by the first ends of the first and second side panels respectively,
a second end defined by the second ends of the first and second side panels respectively,
the discrete strip disposed between the first and second side panels, the first surface of the discrete strip sealed to the inner surface of the first side panel, the second surface of the discrete strip sealed to the inner surface of the second side panel, and the discrete strip near and spaced apart from the first end of the pouch, and spaced apart from the second end of the pouch;
a first opening flap comprising a portion of the first side panel between the discrete strip and the first end of the first side panel;
a second opening flap comprising a portion of the second side panel between the discrete strip and the first end of the second side panel; and
the product; and
before or during the step of putting a product in the first pouch, anchoring the discrete strip to the lay-flat web or folded web.

Optionally, according to various embodiments of the sixth aspect of the invention:
the second end of the first side panel, and the second end of the second side panel, are joined together by a seal.
the discrete strip is disposed perpendicular to the first and second side edges of the first and second side panel respectively.
the package is absent any zipper.
the package can be opened with a peel force of from 25 grams/inch to 5 pounds/inch.

In a seventh aspect, a method of making an easy-open package in a vertical form/fill/seal process comprises:

providing a lay-flat web;
providing a discrete strip comprising a first and second surface each comprising a sealant, at least one of the first and second surfaces comprising an easy-open sealant, the discrete strip anchored to the lay-flat web;
advancing the lay-flat web with the discrete strip anchored thereto over a forming device to convert the lay-flat web to a folded web having an interior surface;
making a longitudinal seal in the folded web;
transversely sealing the folded web to produce a first transverse seal in the folded web to define a first pouch, wherein the first transverse seal is a bottom transverse seal of the first pouch;
putting a product in the first pouch;
advancing the folded web, with the first pouch, downward a predetermined distance;
sealing the discrete strip to the interior surface of the folded web to produce a top transverse seal in the first pouch;
sealing the folded web to produce a bottom transverse seal in a second pouch, the second pouch disposed above the first pouch, wherein the bottom transverse seal of the second pouch is disposed above, and spaced apart from, the top transverse seal of the first pouch; and
transversely cutting the folded web, at a line above and spaced apart from the top transverse seal of the first pouch, and below the bottom transverse seal of the second pouch, to separate the first pouch from the second pouch to make a package, the package comprising
a first and second side panel each comprising an outer and inner surface, a first and second side edge, and a first and second end, the first and second side panels joined together along their respective first and second side edges,
a first end defined by the first ends of the first and second side panels respectively,
a second end defined by the second ends of the first and second side panels respectively,
the discrete strip disposed between the first and second side panels, the first surface of the discrete strip sealed to the inner surface of the first side panel, the second surface of the discrete strip sealed to the inner surface of the second side panel, and the discrete strip near and spaced apart from the first end of the pouch, and spaced apart from the second end of the pouch;
a first opening flap comprising a portion of the first side panel between the discrete strip and the first end of the first side panel;
a second opening flap comprising a portion of the second side panel between the discrete strip and the first end of the second side panel; and
the product.

Optionally, according to various embodiments of the seventh aspect of the invention:
the second end of the first side panel, and the second end of the second side panel, are joined together by a seal.
the discrete strip is disposed perpendicular to the first and second side edges of the first and second side panel respectively.
the package is absent any zipper.
the package can be opened with a peel force of from 25 grams/inch to 5 pounds/inch.

In an eighth aspect, a method of making an easy-open package in a vertical form/fill/seal process comprises:

providing a lay-flat web;
providing a discrete strip comprising a first and second surface each comprising a sealant, at least one of the first and second surfaces comprising an easy-open sealant;
advancing the lay-flat web over a forming device to convert the lay-flat web to a folded web having an interior and exterior surface;
advancing the discrete strip such that when the package is made, the discrete strip is disposed between a first and second side panel of the package;
sealing the first and second surfaces of the discrete strip to the interior surface of the folded web;
making a longitudinal seal in the folded web;
transversely sealing the folded web to produce a first transverse seal in the folded web to define a first pouch, wherein the first transverse seal is the bottom transverse seal of the first pouch;
putting a product in the first pouch;
advancing the folded web, with the first pouch, downward a predetermined distance;
transversely sealing the folded web to simultaneously produce a top transverse seal in the first pouch, and a bottom transverse seal in a second pouch, the second pouch disposed above the first pouch;
transversely cutting the folded web, at a line between the top transverse seal of the first pouch, and the bottom transverse seal of the second pouch, to separate the first pouch from the second pouch to make a package, the package comprising
the first and second side panel each comprising a first and second end,
a first end defined by the first ends of the first and second side panels respectively,
a second end defined by the second ends of the first and second side panels respectively,
the discrete strip disposed between the first and second side panels,
a first opening flap; and
the product; and
before or during the step of putting a product in the first pouch, anchoring the discrete strip to the lay-flat web or folded web.

Optionally, according to various embodiments of the eighth aspect of the invention:
the package is absent any zipper.
the package can be opened with a peel force of from 25 grams/inch to 5 pounds/inch.

In a ninth aspect, a method of making an easy-open package in a vertical form/fill/seal process comprises:

providing a lay-flat web;
providing a discrete strip comprising a first and second surface each comprising a sealant, at least one of the first and second surfaces comprising an easy-open sealant, the discrete strip anchored to the lay-flat web;
advancing the lay-flat web with the discrete strip anchored thereto over a forming device to convert the lay-flat web to a folded web having an interior and exterior surface;
sealing the first and second surfaces of the discrete strip to the interior surface of the folded web;
making a longitudinal seal in the folded web;
transversely sealing the folded web to produce a first transverse seal in the folded web to define a first pouch, wherein the first transverse seal is the bottom transverse seal of the first pouch;
putting a product in the first pouch;
advancing the folded web, with the first pouch, downward a predetermined distance;
transversely sealing the folded web to simultaneously produce a top transverse seal in the first pouch, and a bottom transverse seal in a second pouch, the second pouch disposed above the first pouch;
transversely cutting the folded web, at a line between the top transverse seal of the first pouch, and the bottom transverse seal of the second pouch, to separate the first pouch from the second pouch to make a package, the package comprising
a first and second side panel each comprising a first and second end,
a first end defined by the first ends of the first and second side panels respectively,
a second end defined by the second ends of the first and second side panels respectively,
the discrete strip disposed between the first and second side panels,
a first opening flap; and
the product.

Optionally, according to various embodiments of the ninth aspect of the invention:
the package is absent any zipper.
the package can be opened with a peel force of from 25 grams/inch to 5 pounds/inch.

In a tenth aspect, a method of making an easy-open package having a formed web comprises:

providing a formed web comprising a product cavity;
providing a product;
providing a lidstock, having a first and second surface, comprising a lay-flat web;
providing a discrete strip comprising a first and second surface each comprising a sealant, at least one of the first and second surfaces comprising an easy-open sealant;
placing the product in the product cavity;
sealing the lidstock to the formed web, such that the discrete strip is disposed between and sealed to the lidstock and the formed web; and
cutting the lidstock and formed web to make the package;
wherein the package has an opening flap; and
at any time during the method of making the package, the discrete strip is anchored to the lidstock.

Optionally, according to various embodiments of the tenth aspect of the invention:
the package is absent any zipper.
the package can be opened with a peel force of from 25 grams/inch to 5 pounds/inch.

In a eleventh aspect, a method of making an easy-open package having a formed web comprises:

providing a formed web comprising a product cavity;
providing a product;
providing a lidstock, having a first and second surface, comprising a lay-flat web;
providing a discrete strip comprising a first and second surface each comprising a sealant, at least one of the first and second surfaces comprising an easy-open sealant, the discrete strip anchored to the lidstock;
placing the product in the product cavity;
sealing the lidstock, with the discrete strip anchored thereto, to the formed web, such that the discrete strip is disposed between and sealed to the lidstock and the formed web; and
cutting the lidstock and formed web to make the package;
wherein the package has an opening flap.

Optionally, according to various embodiments of the eleventh aspect of the invention:
the package is absent any zipper.
the package can be opened with a peel force of from 25 grams/inch to 5 pounds/inch.

In a twelfth aspect, a method of making an easy-open package in a continuous horizontal packaging process comprises:

providing a lay-flat web;
providing a discrete strip comprising a first and second surface each comprising a sealant, at least one of the first and second surfaces comprising an easy-open sealant;
advancing the lay-flat web to a forming device to convert the lay-flat web into a folded web having an inner surface;
advancing the discrete strip such that when the package is made, the discrete strip is disposed between a first and second side panel of the package;
advancing a product to the forming device such that the folded web envelopes the product;
longitudinally sealing the folded web to make a longitudinal seal;
transversely sealing the folded web, with the product therein, to produce a leading transverse seal to define a first pouch;
advancing the folded web, with the leading transverse seal, forward a predetermined distance; transversely sealing the folded web to produce a trailing transverse seal in the first pouch, and a leading transverse seal in a second pouch, the second pouch disposed upstream of the first pouch; and
cutting the transversely sealed formed web, with the product therein, to form an individual package in which the discrete strip is sealed to the inner surface of the folded web;
wherein at any time during the method of making the package, sealing the first and second surfaces of the discrete strip to the inner surface of the folded web.

Optionally, according to various embodiments of the twelfth aspect of the invention:
the package is absent any zipper.
the package can be opened with a peel force of from 25 grams/inch to 5 pounds/inch.

In a thirteenth aspect, a method of making an easy-open package in a continuous horizontal packaging process comprises:

providing a lay-flat web;
providing a discrete strip comprising a first and second surface each comprising a sealant, at least one of the first and second surfaces comprising an easy-open sealant, the discrete strip anchored to the lay-flat web;
advancing the lay-flat web with the discrete strip anchored thereto to a forming device to convert the lay-flat web into a folded web having an inner surface;
advancing the discrete strip such that when the package is made, the discrete strip is disposed between a first and second side panel of the package;
advancing a product to the forming device such that the folded web envelopes the product;
longitudinally sealing the folded web to make a longitudinal seal;
transversely sealing the folded web, with the product therein, to produce a leading transverse seal to define a first pouch;
advancing the folded web, with the leading transverse seal, forward a predetermined distance;
transversely sealing the folded web to produce a trailing transverse seal in the first pouch, and a leading transverse seal in a second pouch, the second pouch disposed upstream of the first pouch; and
cutting the transversely sealed formed web, with the product therein, to form an individual package in which the discrete strip is sealed to the inner surface of the folded web;
wherein at any time during the method of making the package, sealing the first and second surfaces of the discrete strip to the inner surface of the folded web.

Optionally, according to various embodiments of the thirteenth aspect of the invention:
the package is absent any zipper.
the package can be opened with a peel force of from 25 grams/inch to 5 pounds/inch.

In a fourteenth aspect, a pouch comprises:

a first and second side panel each comprising an outer and inner surface, a first and second side edge, and a first and second end, the first and second side panels joined together along their respective first and second side edges;
a first end defined by the first end of at least one of the first and second side panels respectively;
a second end defined by the second ends of the first and second side panels respectively;
the first and second side panels joined together along their respective second ends;
a discrete strip disposed between the first and second side panels, the discrete strip comprising a first and second surface, wherein
the first and second surface each comprises a sealant,
at least one of the first and second surfaces comprises an easy-open sealant,
the first surface is sealed to the inner surface of the first side panel, or the second surface is sealed to the inner surface of the second side panel, and
the discrete strip is near and spaced apart from the first end of the pouch, and spaced apart from the second end of the pouch;
   a first opening flap comprising a portion of the first side panel between the discrete strip and the first end of the first side panel, and
   a second opening flap comprising a portion of the second side panel between the discrete strip and the first end of the second side panel.

Optionally, according to various embodiments of the fourteenth aspect of the invention:
the first and second side panels are joined together along their respective first and second transverse edges by a seal.
the first and second side panels are joined together along their respective first and second transverse edges by a fold.
the second end of the first side panel, and the second end of the second side panel, are joined together by a seal.
the second end of the first side panel, and the second end of the second side panel, are joined together by a fold.
the discrete strip is disposed perpendicular to the first and second side edges of the first and second side panel respectively.
the pouch, and a package made from the pouch, is absent any zipper.
a package made from the pouch can be opened with a peel force of from 25 grams/inch to 5 pounds/inch.

In a fifteenth aspect, a method of making a bag with a discrete strip disposed thereon comprises:

extruding a thermoplastic tube to make a bag tubing;
providing a discrete strip comprising a first and second surface each comprising a sealant, at least one of the first and second surfaces comprising an easy-open sealant;
slitting the tubing at a longitudinal edge thereof to make a slit bag tubing;
placing the discrete strip inside the slit bag tubing; and
transversely cutting and sealing the slit bag tubing at predetermined intervals to make a plurality of individual bags, each bag comprising
a first and second side panel each comprising, an outer and inner surface, first and second side edges, and a first and second end, the first and second side panels joined together along at least a portion of their respective first and second side edges by a seal,
a first end defined by the first end of at least one of the first and second side panels,
an end fold defined by the second ends of the first and second side panels respectively, and
the discrete strip disposed between the first and second side panels, and spaced apart from the first end and the end fold of the bag;
   wherein at any time before transversely cutting the bag tubing to produce a bag, the discrete strip is anchored to the bag tubing or slit bag tubing.

Optionally, according to various embodiments of the fifteenth aspect of the invention:

the bag, and a package made from the bag, is absent any zipper.

the bag, and a package made from the bag, can be opened with a peel force of from 25 grams/inch to 5 pounds/inch.

### BRIEF DESCRIPTION OF THE DRAWINGS

The present invention is illustrated by reference to the following drawings, encompassing different views of various embodiments of the invention, wherein:

FIG. 1 is an elevational view of a package;

FIG. 2 is an enlarged view of the package of FIG. 1;

FIG. 3 is a front view of the package of FIG. 1, viewed along lines 3-3 of FIG. 1;

FIG. 4 is a back view of the package of FIG. 1, viewed along lines 4-4 of FIG. 1;

FIG. 5 an enlarged view of the package of FIG. 1 according to another embodiment;

FIG. 6 is a cross-sectional view of a discrete strip;

FIG. 7 is a cross-sectional view of a discrete strip according to another embodiment;

FIG. 8A is a perspective view of a HFFS process and apparatus for making a package;

FIG. 8B is a perspective view of a HFFS process and apparatus for making a package according to another embodiment;

FIG. 9A is a perspective view of a HFFS process and apparatus for making a package according to another embodiment;

FIG. 9B is a perspective view of a HFFS process and apparatus for making a package according to another embodiment;

FIG. 9C is a perspective view of a section of folded web in connection with one embodiment;

FIG. 9D is a perspective view of a section of gusseted folded web;

FIG. 10 is an elevational view of a VFFS process and apparatus for making a package;

FIG. 11 is an elevational view of a VFFS process and apparatus for making a package according to another embodiment;

FIG. 12 is a perspective view of a roll of lay-flat film and a discrete strip;

FIG. 13 is a perspective view of a roll of lay-flat film and a discrete strip according to another embodiment;

FIG. 14 is a perspective of a roll of lay-flat film and a discrete strip according to yet another embodiment;

FIG. 15 is a front view of an alternative embodiment of the package;

FIG. 16 is a back view of the package of FIG. 15;

FIG. 17 is an elevational view of two consecutive pouches in a VFFS embodiment;

FIG. 18 is a front view of an alternative embodiment of the package;

FIG. 19 is a front view of an alternative embodiment of the package;

FIG. 20 is an isometric view of an alternative embodiment of the package;

FIG. 21A is an isometric view of an alternative embodiment of the package;

FIG. 21B is a perspective view of an alternative embodiment of the package;

FIG. 22 is a cross sectional view of a tray for use in connection with the invention.

FIG. 23A is a perspective view of a package;

FIG. 23B is a perspective view of the package of FIG. 23A in a partially opened condition;

FIG. 24 is a top plan view of a lidstock in connection with the invention;

FIG. 25 is a top plan view of a lidstock according to another embodiment;

FIG. 26 is an elevational view of a continuous horizontal packaging process and apparatus for making a package;

FIG. 27 a front end view of the apparatus of FIG. 26, viewed along lines 27-27 of FIG. 26;

FIG. 28 is a plan view of an alternative embodiment of the invention; and

FIG. 29 is a cross sectional view of FIG. 28.

### DEFINITIONS

“Anchor”, “anchored”, “anchoring” and the like herein refers to attaching two surfaces together, e.g. by sealing or adhering, and refers to the resulting bond between surfaces. Sealing is done by means of a sealant. Adhering is done by means of an adhesive.

In processes described herein where a strip is anchored to a web or side panel, either during the process wherein the web and strip are advanced, or when a strip has been pre-anchored to the web before the start of the process, anchoring can be done by use of any suitable continuous or discontinuous sealing or adhesive material and method. Such anchoring is done to hold the strip to the web during the relevant packaging process.

In some embodiments, wherein the anchor is already relatively strong or continuous, e.g. a heat seal that constitute either a relatively strong heat seal, or an easy-open seal as defined herein, the anchor functions not only to hold the strip to the web during the relevant packaging process, but also as a final seal of that surface of the strip to the web (lay-flat or folded) or panel made from the web.

Any subsequent disclosed or recited step in the process of sealing one of the surfaces (i.e. the anchored surface) of the strip to a web or panel, is already completed by the anchoring step. In these embodiments, then, contact of a seal device, e.g. a seal bar in the region of the anchor, in a subsequent step, may add no further or separate seal to that surface of the strip.

Any subsequent step in the process of sealing the other surface of the strip to a web or panel, then, may add no further or separate seal to the anchored surface of the strip. Sealing of the surface of the strip to a web, as a process step disclosed or recited herein, should be understood in this light.

In some embodiments where the bond is a relatively weak or discontinuous one, e.g. a discontinuous seal, spots or narrow stripes of adhesive. etc., in a subsequent step of sealing one of the surfaces of the strip to the web or panel, a seal bar that seals one of the surfaces of the strip to the web or panel can contact the web or panel in the region where the anchor is already disposed. The seal in that region may be either enhanced, or initially created, by the subsequent sealing step.

“Discrete” with respect to the discrete strip and the web of material on which the strip is disposed, is used herein to mean independently made (the strip is not an integral part of the web when the web is made) or constituting a separate entity from the web.

“Easy-open” herein refers to a package that can be manually opened relatively easily without the use of tools such as scissors or knives. The physical mode of opening may include actual peeling at the strip/web interface (adhesive failure), or a sealant layer of the strip breaking completely through, and peeling then occurring between the sealant layer and an adjacent layer within the strip (delamination failure), or breaking within a sealant layer by rupturing of the sealant material itself (cohesive failure). The peel force required to open the package can be measured by an evaluation of seal strength or peel strength in accordance with the test procedure set out in ASTM F88, incorporated herein by reference in its entirety, using a cross-head speed of 8 to 12 inches/minute and an initial jaw gap of from 1.00 inch to 2.00 inch. Typical peel forces for opening the package of the invention can range from e.g. 25 grams/inch to 3 pounds/inch, e.g. from 100 grams/inch to 2 pounds/inch, such as from 200 grams/inch to 1.5 pounds/inch. In some cases, the sealant may actually peel away from the surface to which it is adhered, or alternatively a rupture of the sealant (cohesive failure) or even breakage of the sealant and delamination along an adjacent layer interface may occur. Depending on the design and geometry of the seal, peel forces can in some embodiments be higher than 3 pounds/inch, e.g. 3.5, 4.0, 4.5, or 5 pounds/inch, or values intermediate these values.

“Easy-open seal” herein refers to a seal involving the discrete strip and web in which materials are chosen for the discrete strip and web such that the package is easy-open with a physical mode of opening of adhesive failure, delamination failure, or cohesive failure as described herein.

“Easy-open sealant” herein refers to a material chosen for one or both surfaces of the discrete strip, such that when such surface is sealed to a web, it provides a package that is easy-open with a physical mode of opening of adhesive failure, delamination failure, or cohesive failure as described herein.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. EAO includes heterogeneous materials such as linear medium density polyethylene (LMDPE), linear low density polyethylene (LLDPE), and very low and ultra low density polyethylene (VLDPE and ULDPE); single-site catalyzed materials such as homogeneous linear ethylene/alpha olefin copolymers and long chain branched ethylene/alpha olefin copolymers; and multicomponent ethylene/alpha-olefin interpenetrating network resin (or “IPN resin”).

“Ethylene homopolymer or copolymer” herein refers to polyethylene (PE) such as ethylene homopolymer such as low density polyethylene (LDPE), medium density polyethylene (MDPE), high density polyethylene (HDPE); ethylene/alpha olefin copolymer such as those defined herein; ethylene/vinyl acetate copolymer (EVA); ethylene/alkyl acrylate copolymer such as ethylene/methyl acrylate copolymer (EMA) or ethylene/ethyl acrylate copolymer (EEA), or ethylene/butyl acrylate copolymer (EBA); ethylene/(meth)acrylic acid copolymer; or ionomer resin (IO).

“Film” is used herein to mean a thermoplastic film, laminate, or web, either multilayer or monolayer, that may be used in connection with the present invention. Film can be of any suitable thickness, e.g. between 0.1 and 30 mils.

“Fin seal” is used herein to mean, in the case of a single web, folding one edge of a web towards the opposite edge of the web, and sealing the facing inner surfaces together. In the case of two webs, a fin seal is a seal formed by sealing the inner surface of the edge of one web to the inner surface of a corresponding edge of another web.

“Lap seal” is used herein to mean a seal made by sealing an inside surface of a web to an outside surface of a web. The inside and outside surfaces can both be on a single web; or the inside surface can be of one web, and the outside surface of a second web.

“Lidstock” herein refers to a film used to cover a container or tray that carries a product, and can be sealed to the tray, typically as a perimeter heat seal. Lidstock typically is supplied to a food processor in a lay flat film rolled onto a roll.

“Longitudinal seal” herein refers to a fin seal or lap seal.

“Olefinic” and the like herein refers to a polymer or copolymer derived at least in part from an olefinic monomer.

“Oxygen barrier” and the like herein refers to materials having an oxygen permeability, of the barrier material, less than 500 cm³ O₂/m²·day·atmosphere (tested at 1 mil thick and at 25° C., 0% RH according to ASTM D3985), such as less than 100, less than 50, less than 25, less than 10, less than 5, and less than 1 cm³ O₂/m²·day·atmosphere. Examples of polymeric materials useful as oxygen barrier materials are ethylene/vinyl alcohol copolymer (EVOH), polyvinylidene dichloride (PVDC), vinylidene chloride/methyl acrylate copolymer, vinylidene chloride/vinyl chloride copolymer, polyamide (nylon), and polyester (PET).

“Polymer” and the like herein means a homopolymer, but also a copolymer thereof, including terpolymer, tetrapolymer, block copolymer, etc.

“Pouch” herein means a pouch or bag.

“Registration device” herein refers to any mark, pattern, or feature of a web or strip, such as eye-spots, that facilitates the advancement of the web or strip, in a controlled manner, into a packaging machine, where the web or strip is used to make individual packages. The device can be e.g. printed or placed in uniformly spaced fashion along or near an edge of the web or strip, i.e. registration marks, or in an area near the middle of a web that does not interfere with decorative printed graphics. These marks are used in connection with appropriate sensors to controllably advance the web or strip.

“Seal” herein means a bond between two thermoplastic surfaces, e.g. as produced by heat sealing, radio frequency (RF) sealing, ultrasonic sealing, or permanent adhesive.

“Sealant” is a polymeric material, such as an olefinic polymer or copolymer such as an ethylenic polymer or copolymer, that can form a surface of the discrete strip of the invention, or a web to which the strip is sealed, and form a seal between two thermoplastic surfaces. A permanent adhesive can also be a sealant. “Sealant” herein, with respect to the discrete strip, or a web to which the strip is adhered, herein excludes a repositionable adhesive or pressure sensitive adhesive.

“Strip” herein refers to an elongate piece of thermoplastic material, typically longer in a first direction than in a direction perpendicular to the first direction, e.g. rectangular; but can also be square, round, oblong, elliptical, or any appropriate shape in plan view. The strip can be of any suitable thickness, e.g. between 0.1 and 30 mils.

“Thermoplastic” herein includes plastic materials that when heated to a softening or melting point may be reshaped without significant thermal degradation (burning). Thermoplastic includes both materials that are not crosslinked, or that are crosslinked by chemical or radiation means.

“Tray” herein refers to a formed member that has a tray bottom, tray sides, and a tray flange around the upper perimeter of the tray, where the tray bottom and tray sides form an internal cavity within which a product can be placed. The cavity can be enclosed by a lidstock sealed to the tray flange.

“Web” is used herein to mean a thermoplastic film, laminate, or web, either multilayer or monolayer, that may be used in connection with the present invention. The web can be of any suitable thickness, e.g. between 0.1 and 30 mils, and any suitable length and width.

“Zipper” and the like herein refers to a plastic zipper closure; press-to-close or slide zipper; interlocking closure; reclosable fastener with interlockable fastener elements; interlocking rib and groove elements having male and female profiles; interlocking alternating hook-shaped closure, and the like.

All compositional percentages used herein are presented on a “by weight” basis, unless designated otherwise.

Drawings herein are not necessarily to scale, and certain features of the invention may be graphically exaggerated for clarity.

### DETAILED DESCRIPTION OF THE INVENTION

### 1. Package

Referring to the drawings, an easy-open package 5 in accordance with the invention includes a pouch 7 that can be made from either a single web, or two webs, to form a first or front side panel 12, and a second or back side panel 14.

A. Web(s)

In either embodiment, the web or webs comprises a thermoplastic material of any suitable composition, including those having as at least one component olefinic materials such as ethylene or propylene polymers or copolymers, e.g. PE or EAO copolymers; and including films or laminates typically used in, or useful in, HFFS, VFFS, lidstock/tray, and continuous horizontal packaging (Flow-wrap) apparatus and processes. The web or webs can be monolayer or multilayer in construction, can be coextruded, laminated, or made by any suitable film making process, and can have any suitable thickness.

Examples of film constructions for the web(s) used in accordance with the invention include H7225B™, a barrier hybrid material used for products requiring a high oxygen barrier, such as shredded cheese; CP04140™, a low barrier (high OTR) material used in produce packaging, CPM4090, a microwaveable packaging film for fresh cut produce; and T7225B™, a barrier material used as lidstock for products requiring a high oxygen barrier, such as luncheon meat. These are all commercial products produced by the Cryovac business unit of Sealed Air Corporation.

H7225B™ is a laminate having the construction PET//adhesive//coextruded barrier film, where the PET is a biaxially oriented polyester film, and the barrier film has the construction LDPE (low density polyethylene)/EVA tie/nylon/EVOH+nylon/nylon/EVA tie/EAO. The overall thickness of the laminate can be any of several gauges, being typically about 2.5 mils. The LDPE is the surface of the barrier film adhered, by the adhesive, to the PET film. The EAO typically acts as the heat sealant layer of the film, and finished laminate, and in packaging made from the laminate, the EAO will form the inner or sealant surface of the package, facing the contained product, and the PET will form the outer or skin surface of the package. H7225B™ can be used as a lidstock (non-forming) web.

CP04140™ is a laminate having the construction BOPP//adhesive/monolayer LLDPE film. A typical gauge for the laminate is about 1.8 mils. The LLDPE typically acts as the heat sealant layer of the finished laminate, and in packaging made from the laminate, the LLDPE will form the inner or sealant surface of the package, facing the contained product, and the BOPP will form the outer or skin surface of the package.

CPM4090 is a laminate having the construction BOPP//adhesive/monolayer LLDPE+LDPE film. A typical gauge for the laminate is about 2 mils. The LLDPE+LDPE layer typically acts as the heat sealant layer of the finished laminate, and in packaging made from the laminate, the LLDPE+LDPE will form the inner or sealant surface of the package, facing the contained product, and the BOPP will form the outer or skin surface of the package.

T7225B™ film has the construction EAO/EAO/LLDPE tie/nylon/EVOH/nylon/EVA tie/EVA tie/nylon. The first layer of EAO typically acts as the heat sealant layer of the film, and in packaging made from the laminate, the EAO will form the inner or sealant surface of the package, facing the contained product, and the nylon of the last layer will form the outer or skin surface of the package. T7225B™ is used as a lidstock (non-forming) web.

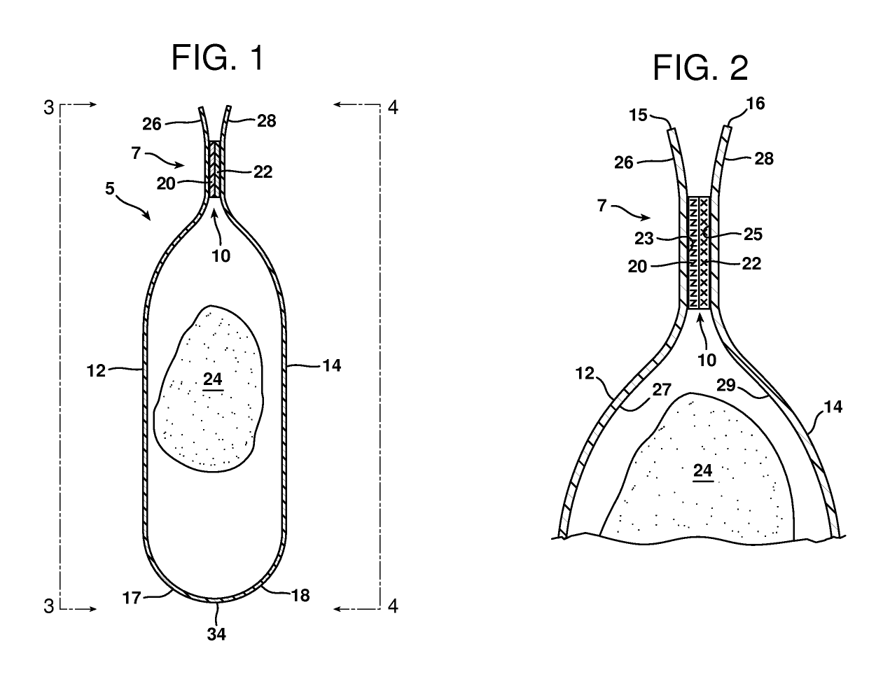

As shown e.g. in FIGS. 1 to 4, first side panel 12 has a first end 15, a first transverse edge 31, a second transverse edge 33, and a second end 17. Second side panel 14 has a first end 16, a first transverse edge 35, a second transverse edge 37, and a second end 18.

First and second side panels 12 and 14 are joined together along their respective first and second transverse edges by either a seal or a fold. As shown, first transverse edge 31 of first side panel 12 is joined to first transverse edge 35 of second side panel 14 by a seal 30. Second transverse edge 33 of first side panel 12 is joined to second transverse edge 37 of second side panel 14 by a seal 32. Second end 34 of pouch 7 can be either a seal or a fold. When a single web of film is used to make the pouch, second end 34 is a fold, although even after the web is folded, a seal such as a heat seal can optionally be installed in the area of the fold if desired. Where two webs of film are used to make panels 12 and 14, second end 34 is a seal that joins panels 12 and 14 together along their respective second ends 17 and 18. The two webs can be made from the same material, or can be different in composition, structure, etc.

B. Discrete Strip

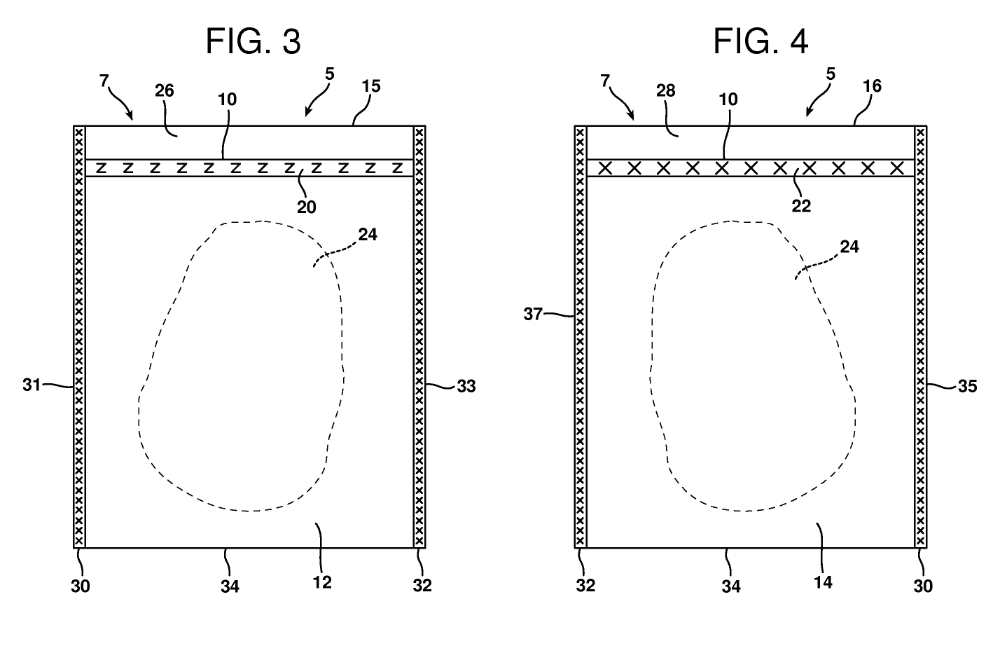

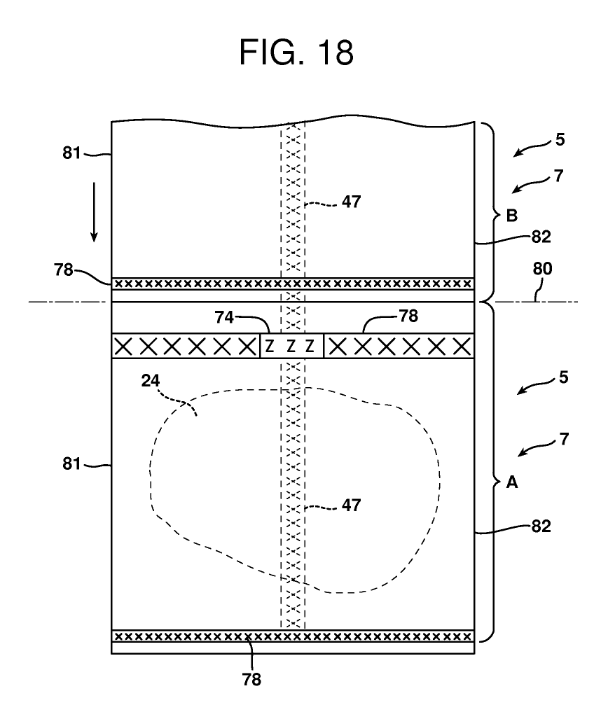

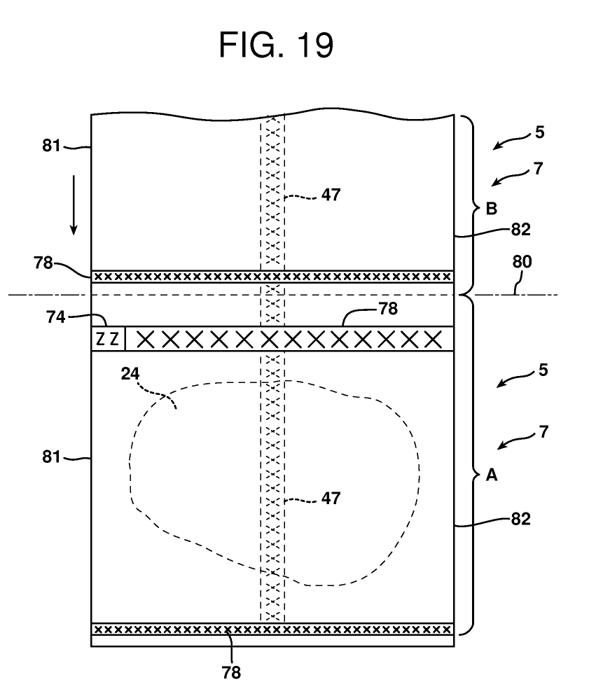

A discrete strip 10 is disposed between first panel 12 and second panel 14, near and spaced apart from the first end of the pouch, and spaced apart from the second end of the pouch. The strip can be of any suitable dimension, and will typically be longer in length than in width, with the length of the strip 10 being e.g. greater than two times the width of the strip, e.g. greater than 3, 4, or 5 times the width. A typical dimension for the strip 10 is a width of 0.25 inches and a length of 7 inches. The strip 10 is shorter in at least one dimension than the pouch and package. For example, the strip can extend across the transverse width of a pouch made in a HFFS or VFFS process, but is significantly narrower than the length of the package (see e.g. FIGS. 3 and 4). In one embodiment, the strip will occupy less than 50%, such as less than 40%, less than 30%, less than 20%, or less than 10% of the length of the package. The strip can in another embodiment be shorter in both dimensions than the pouch and package (see e.g. FIGS. 18 and 19). The strip can occupy e.g. less than 50%, such as less than 40%, less than 30%, less than 20%, or less than 10% of each of the length and width of the package. “Near” herein means that the edge of the strip closest to the first end of the pouch and package is typically within about three inches of the first end of the pouch. The strip 10 can be closer than this, such as within about two inches, one inch, 0.75 inches, 0.5, 0.4, 0.3, 0.2, or 0.1 inches of the first end of the pouch.

In some embodiments, first and second opening flaps 26 and 28 can be manually grasped and pulled apart to open the package and access the product. Flaps 26 and 28 with greater length generally facilitate opening of the package, but also involve the use of more material, and shorten the portion of the package available for containing the product, working with a given overall package length. Flaps 26 and 28 with shorter length generally involve the use of less material, and expand the portion of the package available for containing the product, working with a given overall package length; but can be more difficult to use in opening the package because relatively little material at the first end of the package is available to grasp. Flaps 26 and 28 with a length less than about 0.3 inches may prove difficult to use. The size of the package, the type of materials used for the pouch and the strip, the seal strength of the materials used in the strip, and the type of product being packaged can all have some effect on the choice of the optimal length of opening flaps 26 and 28. In other embodiments where lap seals are used to close the pouch and include therein the discrete strip, only one opening flap is available for opening the package.

Strip 10 comprises a first major surface 23 and a second major surface 25, each comprising a sealant. First surface 23 is sealed to the inner surface 27 of the first side panel 12, and second surface 25 is sealed to the inner surface 29 of the second side panel 14. The film strip can be of multilayer or monolayer construction.

When product 24 is placed in pouch 7, by processes herein disclosed, and pouch 7 is closed, package 5 is made.

C. Opening Mechanisms and Strip Construction

The package of the invention can be easily manually opened. Any suitable mechanism for obtaining this functionality and feature can be used according to the invention. The following are examples of such mechanisms.

1. Adhesive Failure

In this embodiment, surface 23 of strip 10, and the inner surface 27 of the first side panel 12, each comprise a polymeric composition that, when surface 23 is sealed to the inner surface 27, forms an easy-open seal. This seal provides the interface that breaks apart upon manually opening the package. The interlaminar bonds between layers of the strip itself (where the strip is of multilayer construction), the cohesive strength of each layer within the strip, or of the single layer of a monolayer strip, and the seal that holds surface 25 to inner surface 29, are stronger than the seal that holds surface 23 to surface 27.

In some embodiments, the polymeric composition of surfaces 23 and 27 is the same or similar. Useful in these embodiments are the peel systems disclosed in U.S. Pat. Nos. 4,189,519 (Ticknor) (blend of EVA or EMA or EEA with crystalline isotactic polybutylene, and optionally with anhydride grafted EVA); 4,252,846 (Romesberg et al.) (blend of EVA and HDPE, optionally with 10 or polybutylene (PBU)); 4,550,141 (Hoh) (blend of IO and polypropylene/ethylene copolymer (EPC)); 4,666,778 (Hwo) (three component blend of PE, that can be LLDPE, LDPE, MDPE, or HDPE, or EVA or EMA, with PBU, and PP or EPC); 4,882,229 (Hwo) (butene-1 polymer or copolymer blended with modified or unmodified LDPE); 4,916,190 (Hwo) (blend of butylene polymer or copolymer, with PE polymer or copolymer (LLDPE, LDPE, MDPE, EVA, EMA, EEA, EBA, or HDPE), with propylene polymer or copolymer); 4,937,139 (Genske, et al.) (propylene polymer or copolymer blended with HDPE); 5,547,752 (Yanidis) (blend of PBU and IO); and 5,997,968 (Dries et al.)(blend of Component 1 (a copolymer of ethylene and propylene or ethylene and butylene or propylene and butylene or ethylene and another -olefin having 5 to 10 carbon atoms or propylene and another -olefin having 5 to 10 carbon atoms or a terpolymer of ethylene and propylene and butylene or ethylene and propylene and another -olefin having 5 to 10 carbon atoms) and Component 2 (HDPE, MDPE, LDPE, LLDPE or VLDPE); these U.S. patents all incorporated herein by reference in their entirety.

In other embodiments, the polymeric composition of surfaces 23 and 27 will differ in their compositions, i.e. dissimilar sealants are used. Useful in these embodiments are the peel systems disclosed in U.S. Pat. Nos. 3,655,503 (Stanley et al.) (LDPE or MDPE sealed to polypropylene (PP), EPC, saran, nylon 6, polycarbonate (PC), polyvinyl chloride (PVC), or poly-ethylene oxide (PEO); PP sealed to saran, nylon 6, PC, PVC, PEO, IO, phenoxy, or EVA; or nylon sealed to IO); 4,729,476 (Lulham et al.) (a blend of EVA and IO sealed to 10); 4,784,885 (Carespodi) (PP, HDPE, or LLDPE sealed to substantially linear PE (HDPE, LLDPE) blended with a polyolefinic thermoplastic elastomer such as ethylene propylene diene monomer (EPDM), EPM, butyl rubber, halogenated butyl rubber, isoprene rubber, and styrene butadiene rubber); 4,859,514 ((Friedrich et al.) (IO or IO blended with EVA, sealed to a blend of EVA and ethylene butene copolymer (EBC) and PP); 5,023,121 (Pockat, et al.)(a blend of PBU and PP and a third polymeric material selected from EVA, LDPE, LDPE, and IO, sealed to EVA, LDPE, LLDPE, or IO); these U.S. patents all incorporated herein by reference in their entirety.

2. Delamination Failure

In this embodiment, one of the interlaminar bonds between layers of the discrete strip itself (where the discrete strip is of multilayer construction) can be broken. Thus, the interlaminar bond provides the interface that will break apart upon manually opening the package. The seal between surfaces 23 and 27; and between surfaces 25 and 29, and the cohesive strength of each layer within the strip, are stronger than the interlaminar bond. Useful in this embodiment are the peel systems disclosed in U.S. Pat. No. 4,944,409 (Busche et al.), this patent incorporated herein by reference in its entirety.

3. Cohesive Failure

In this embodiment, one of the layers of the strip itself (where the strip is of multilayer construction) or the monolayer strip, fractures when the package is opened. The seal between surfaces 23 and 27, and surfaces 25 and 29, and the interlaminar bonds between layers of the strip itself (where the discrete strip is of multilayer construction) are stronger than the layer that fractures. Useful in this embodiment is the peel system disclosed in U.S. Pat. No. 6,476,137 (Longo) (internal rupture of a sealant layer comprising a blend of an ionomer having a melt flow index of less than 5, and a modified ethylene/vinyl acetate copolymer having a substantially higher melt flow index, where the melt flow indices of the two polymers in the seal layer differ by at least 10), this patent incorporated herein by reference in its entirety.

Other peel systems useful in connection with the present invention are those disclosed in U.S. Pat. Nos. 4,058,632 (Evans et al.), 4,615,926 (Hsu et al.); 5,128,414 (Hwo); 6,395,321 (Schaft et al.), 7,055,683 (Bourque et al.), and US Patent Publication Nos. 20030152669 (Vadhar et al.) and 2008/0260305 (Shah et al.) (disclosing as easy-open sealant, DuPont APPEEL™ resins, such as those based on EVA, modified EVA, EAA, or modified EAA; polyethylenes such as LDPE and/or EVA blended with PP; LDPE or EVA blended with polybutene-1, or random propylene/ethylene copolymer blended with polybutene-1; EVA or LDPE blended with PP; LDPE blended with EVA and PP; such blends provide an easy-open sealant when adhered to polyethylene sealants); these U.S. patents and publications all incorporated herein by reference in their entirety.

Strip 10 can have any suitable number of layers. In FIGS. 1 and 2, strip 10 has two layers. Layer 20 comprises a polymeric composition that provides an easy-open seal when sealed at surface 23 to inner surface 27. Layer 22 comprises a polymeric composition that exhibits a relatively strong seal when sealed at surface 25 to inner surface 29.

The layer of strip 10 that provides an easy-open surface is designated with a series of “Z” markings in the drawings. The layer of the film strip 10 that provides a surface with a greater seal strength is designated with a series of “X” markings.

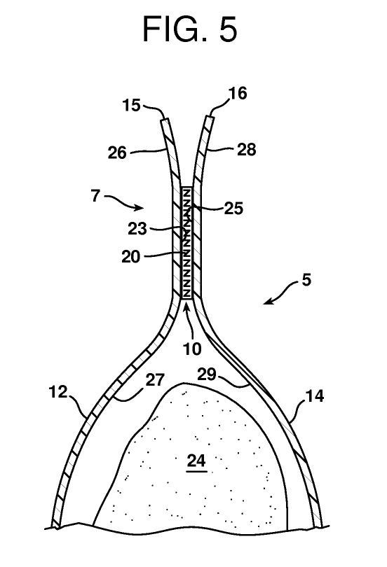

Alternatively, (FIG. 5), strip 10 is of monolayer construction. Layer 20 comprises a polymeric composition that exhibits an easy-open seal when sealed at surface 23 to inner surface 27; and likewise exhibits an easy-open seal when sealed at surface 25 to inner surface 29.

In opening the package of FIGS. 1 to 4, the first and second opening flaps 26 and 28 are manually grasped and pulled apart, and the package opens e.g. by a break in the bond formed at the interface between surfaces 23 and 27. The seal between surfaces 25 and 29 will typically remain intact, such that strip 10 stays on and in contact with surface 29 due to the higher peel force of surface 25.

In opening the package of FIG. 5, the first and second opening flaps 26 and 28 are manually grasped and pulled apart, and the package opens e.g. by a break either in the bond formed at the interface between surfaces 23 and 27; or in the bond formed at the interface between surfaces 25 and 29.

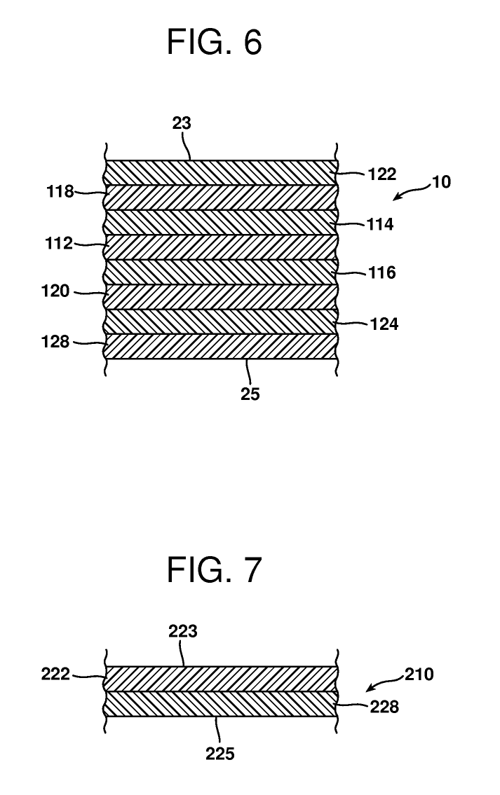

A representative film structure “A1” suitable for use as strip 10 is shown in FIG. 6. This film has the composition shown in Table 1.

TABLE 1
(Example 1)

| | | Gauge | Gauge | Gauge |
|---|---|---|---|---|
| Layer | Composition | (thickness %) | (mils) | (μm) |
| 122 | EZ1 | 25.00 | 0.50 | 12.7 |
| 118 | AD1 | 7.50 | 0.15 | 3.8 |
| 114 | 80% NY1 + 20% NY2 | 7.50 | 0.15 | 3.8 |
| 112 | OB1 | 10.0 | 0.20 | 5.1 |
| 116 | 80% NY1 + 20% NY2 | 7.50 | 0.15 | 3.8 |
| 120 | AD1 | 7.50 | 0.15 | 3.8 |
| 124 | 65% AD2 + 35% PE1 | 17.50 | 0.35 | 8.9 |
| 128 | PE1 | 17.50 | 0.35 | 8.9 |

This example of a material suitable as strip 10 is a barrier film with an easy-open sealant, and is currently used as a barrier/easy-open component of various laminated materials that also include a polyester film component, sold commercially by the Cryovac business unit of Sealed Air Corporation, under designations including H52XXBZ, and H72XXBZ. These are sold as primary packaging materials, i.e. webs that form the main body of the package, not as discrete strips to be used in combination with a primary web.

This material is placed in a seal area of the package. The easy-open sealant layer 122 of A1 exhibits a peel force of typically 2 pounds/inch (ASTM F88). Layer 128 of A1 yields a peel force of typically 8 pounds/inch.

The resins disclosed in Table 1 are identified in Table 2.

TABLE 2

| Material | Tradename Or | |
|---|---|---|
| Code | Designation | Source(s) |
| AD1 | PLEXAR ™PX1007 ™ | Equistar |
| AD2 | BYNEL ™39E660 ™ | DuPont |
| EZ1 | APPEEL ™72D727 | DuPont |
| NY1 | ULTRAMID ™ B33 01 | BASF |
| NY2 | GRIVORY ™ G21 | EMS |
| OB1 | SOARNOL ™ ET3803 | Nippon Gohsei |
| PE1 | PE ™1042cs15 | Flint Hills |

AD1 is a maleic anhydride modified EVA that acts as a polymeric adhesive (tie layer material).
AD2 is a maleic anhydride modified EVA that acts as a polymeric adhesive (tie layer material).
EZ1 is a compound polymer blend of 65% ionomer (SURLYN ™ 1650SB), 30% EVA (ELVAX ™ 3134Q), and 5% polybutylene (MONTELL ™ PB8640), each by weight of the blend.
NY1 is nylon 6 (polycaprolactam).
NY2 is an amorphous copolyamide (6I/6T) derived from hexamethylene diamine, isophthalic acid, and terephthalic acid.
OB1 is EVOH with about 38 mole % ethylene.
PE1 is LDPE.

Example 1 as shown has a total thickness ranging from about 2.0 mils to 3.5 mils.

Core layer 112 of the above film structure can comprise any suitable oxygen barrier material, such as EVOH, and can be blended in any suitable proportion with other polymeric materials or organic or inorganic additives as desired.

In one embodiment, intermediate layers 114 and 116 can each comprise 100% semicrystalline polyamide such as nylon 6.

In another embodiment, Intermediate layers 114 and 116 each comprise a blend of an amorphous polyamide and a semicrystalline polyamide.

Tie layers 118 and 120 can comprise any suitable polymeric adhesive that functions to bond two layers together, e.g. EVA, EAO, LDPE, EMA, and anhydride grafted derivatives of these polymers. Tie layers 118 and 120 can be the same, or can differ.

Bulk layer 124 can comprise a suitable polyolefin, such as an EAO; and/or a polymeric adhesive such as those disclosed herein for tie layers 118 and 120.

First outer layer 122 functions as an easy-open sealant layer, and provides a surface 23 that can be sealed to inner surface 27. Layer 122 can comprise any suitable material or blend of materials that provides an easy-open peelable seal when adhered to inner surface 27.

Layer 122 can comprise EZ1. In another embodiment, layer 122 can comprise any suitable resin or resin blend that provides an easy-open peelable sealant.

Second outer layer 128 functions as a sealant layer, and provides a surface 25 that can be sealed to inner surface 29. Layer 128 can comprise any suitable material or blend of materials that provides a relatively strong seal when adhered to the inner surface 29. Layer 128 can comprise PE1. In another embodiment, layer 128, or a sealant layer comparable in function to layer 128, can comprise an EAO such as EXACT™ 3024, a single-site catalyzed linear ethylene/butene copolymer from ExxonMobil with a density of 0.905 g/cc; or AFFINITY™PL 1888G, a single-site catalyzed long chain branched ethylene/octene copolymer from Dow with a density of 0.9035 g/cc.

Additional materials that can optionally be incorporated into one or more of the film layers, as appropriate, include antiblock agents, slip agents, antifog agents, fillers, pigments, dyestuffs, antioxidants, stabilizers, processing aids, plasticizers, fire retardants, UV absorbers, etc.

In general, each layer of strip 10 can have any thickness desired, so long as the strip and package provide the desired functionalities. Typical total film thicknesses are from 0.1 mils to 15 mils, such as 0.2 to 12 mils, such as 0.5 mils to 10 mils, 0.8 mils to 8 mils, and 1 mil to 4 mils. Suitable gauges include 1.5 mils, 2 mils (as in Example 1); and 3 mils.

Discrete strip 10 can have any suitable number of layers.

Thus, by way of example, FIG. 7 shows, in another embodiment, a two layer film 210 having a first outer layer 222 compositionally and functionally like layer 122 of FIG. 6, with a first outer surface 223; and having a second outer layer 228 compositionally and functionally like layer 128 of FIG. 6, with a second outer surface 225.

Two, three, four, five, six, seven, and eight layer films can thus alternatively be produced, that each include the layers described above with respect to the film strip of FIG. 7, with additional layers as needed, using suitable polymers such as olefin homopolymers or copolymers.

In some embodiments, such as the film strip of FIG. 7, an oxygen barrier layer is not necessary, for example in the packaging of produce. In these embodiments, the web or webs that comprise the pouch will typically also not have an oxygen barrier layer.

In contrast, embodiments of film strip 10 that include an oxygen barrier layer are suitable in connection with web or webs for the pouch that include an oxygen barrier layer.

In yet another alternative embodiment, as shown in FIG. 5, a monolayer film strip 10 provides an easy-open sealant that can comprise any suitable sealant as described herein. In this embodiment, both outer surfaces 23 and 25 provide an easy-open peel seal to the package, so that the package can be opened at either film strip/side panel interface. In this embodiment, when opening the package, because two easy-open peel seals are present, peeling may not occur consistently at one film strip/side panel interface, but may instead wander from one interface to the other interface, i.e. may separate unpredictably and inconsistently from the two discrete strip/side panel interfaces. The result can be, upon opening the package, an S-shaped strip suspended between the two side panels. The strip would in any event remain attached at the two transverse edges of the final package, because of the presence of trans-verse seals that hold down the lateral edges of the strip.

The sealant of at least one of these surfaces comprises an easy-open thermoplastic sealant.

Several apparatus and methods described herein can be used to make a package of the invention.

### 2. Method of Making a Package

A. Horizontal Form/Fill/Seal (HFFS)

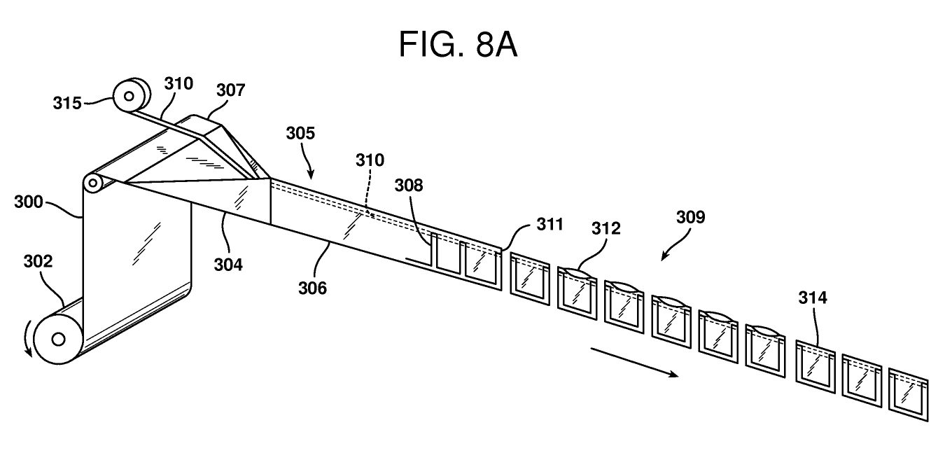

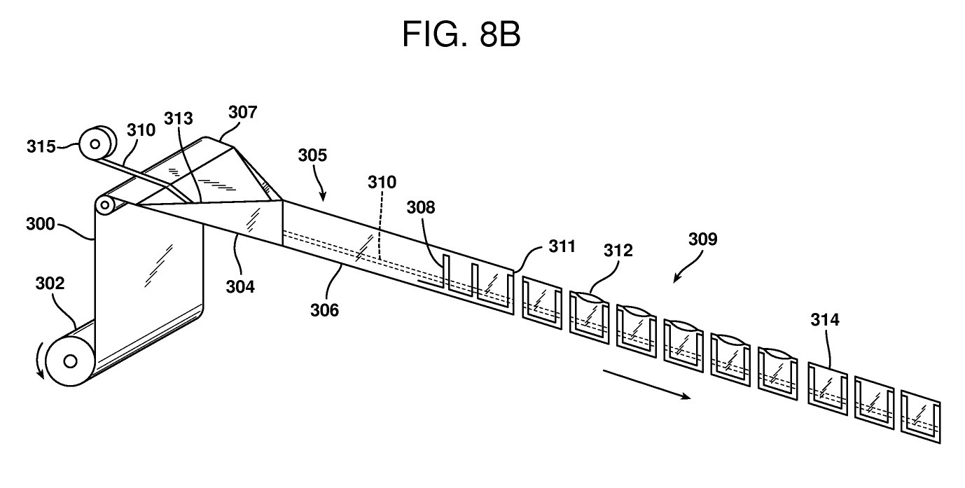

HFFS packaging systems (apparatus and method) are generally well known to those of skill in the packaging industry, and can be used to make packages of the present invention. With reference to FIG. 8A, lay-flat web 300 is unwound from roll 302, then advanced to forming plow 304 to convert lay-flat web 300 to folded web 305 (typically a centerfold film). The second end of each of the pouches to be made will comprise a second end fold 306. Second end fold 306 therefore is equivalent to second end 34 of FIG. 1. This second end fold can be sealed, or left as a folded second end of the pouch. Side seals 308 are made to define a plurality of vertically arranged pouches 309. Each pouch 309 is cut off from the trailing edge of web 300 by an appropriate cutting mechanism (not shown) at position 311, a product (not shown in FIG. 8, but see product 24 in FIGS. 1 to 5) is inserted or dropped into the open mouth 312 of each pouch, and the pouch mouth 312 is then closed by a suitable sealing mechanism such as a heat sealer (not shown) to create a seal 314.

Discrete strip 310, equivalent to strip 10 of FIGS. 1 to 5, can be introduced into the HFFS process in a number of ways. For example, strip 310 can be unwound from a roll 315 in the vicinity of roll 302, and disposed on lay-flat web 300 prior to, or as web 300 is being folded into folded web 305.

In the embodiment of FIG. 8A, the strip is disposed on the web near and spaced apart from, and parallel to, the first longitudinal edge 307 of the lay-flat web 300. This positions the strip, in each individual pouch made by the HFFS process, near and spaced apart from the first end of each pouch, i.e. near and below the open mouth. The upper portions of the first and second side panel will thus function as first and second opening flaps, which can be pulled away from each other to open the package.

In the embodiment of FIG. 8B, the strip is disposed on the web near the centerline of the web, and parallel to, the first longitudinal edge 307 of the lay-flat web 300. This positions the strip, in each individual pouch made by the HFFS process, near and spaced apart from the end fold 306 of each pouch, i.e. near and above the end fold. In this embodiment, a package made from the pouch can be opened by having a line or lines of weakness, such as perforations (not shown), preinstalled and positioned on the web, near and parallel to the end fold 306, between the end fold and the first end of the strip, such that an end portion of the package can be torn off, and the exposed side panels can function as first and second opening flaps, which can be pulled away from each other to open the package. In the package as made in this embodiment, the first and second end flaps remain unattached except at the end fold. A tear notch can be used in place of perforations.

Strip 310 would thus be installed on the pouch in the same overall HFFS process that achieves production of the pouch, loading of a product into the pouch, and completion of the final package. Strip 310 is incorporated into the pouch material and after cutting and sealing as described hereinabove, is disposed between and sealed to the two side panels of each pouch as shown in FIG. 8, and FIGS. 1 to 5.

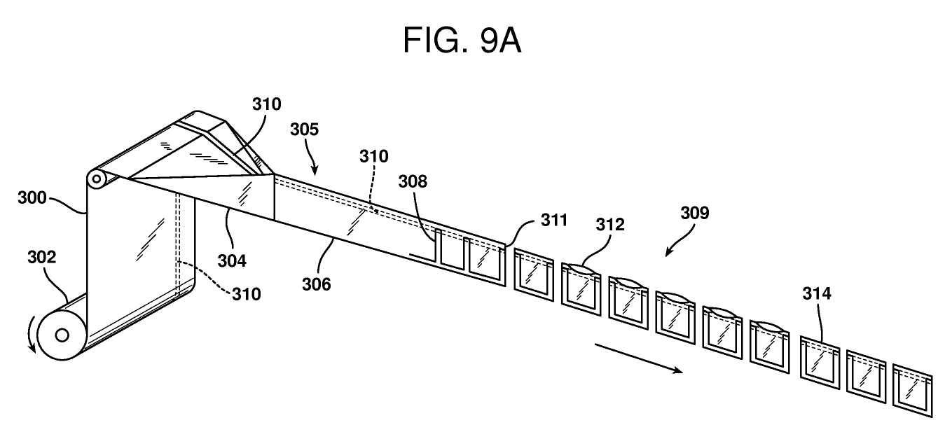

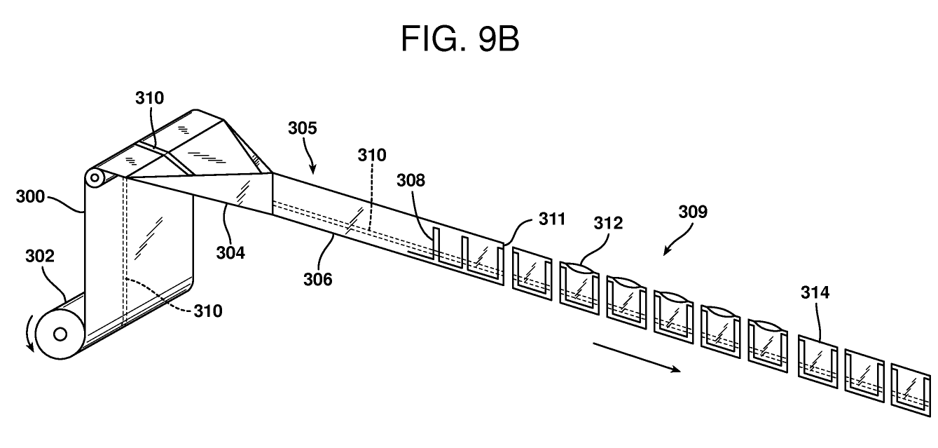

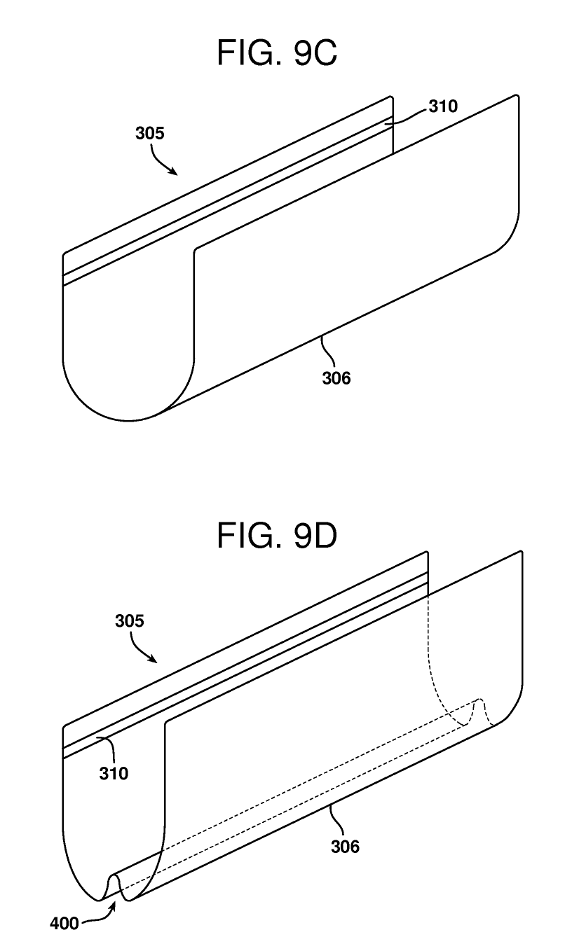

Alternatively (FIGS. 9A and 9B) strip 310 is installed on the lay-flat web prior to the start of the HFFS packaging process. This can be accomplished off-site from the processor, e.g. by the supplier of web roll 302. A disadvantage of this embodiment is the asymmetry caused in the roll profile when strip 310 is wound onto the roll, caused by the build-up in thickness of the roll in the region where the strip is applied, as the result of repeated winds of the roll. In terms of the position of the strip in a pouch, and the opening mechanism, FIGS. 9A and 9B will be similar to FIGS. 8A and 8B respectively.

FIG. 9C is a perspective view of a section of folded web as shown in the HFFS process and apparatus of FIGS. 8A and 9A, as the lay-flat web is folded to create folded web 305. Strip 310 is disposed on, and optionally attached to, inner surface 27 of panel 12 of folded web 305, such that upon sealing the web to create a pouch, panels 12 and 14 (FIGS. 1 and 2) sandwich strip 310 between them.

FIG. 9D is similar to FIG. 9C, but additionally shows optional gusset 400 that can be made in second end fold 306 of the folded web. The gusset can be optionally thereafter heat sealed. A gusseted second end provides a stand-up pouch feature in the final package. Gusseting can be accomplished by any suitable means known to those of skill in the art, such as a second forming plow (not shown) placed in-line in the manufacturing line at a position down-stream of forming plow 304. The second end area of the folded web takes on a generally “W” shape, i.e. a gusseted shape, in cross-section, with the outside legs of the “W” extending upwardly, and two parallel reverse folds to create the gusseted second end. Seal opening or holes are previously punched in the inner legs of the “W” shape and aligned with one another so that the two outside plies can be sealed together through these holes. When the seals are made the outer segments are sealed to one another through the holes. One or more static plows may be mounted above the seal zone to form the gussets. Gusset holes can be die punched by a static die at a hole-punch station which intermittently punches at least two holes at a predetermined position designed to be in general alignment with the side seal, adding rigidity to the gusset portion of the final package. This added rigidity enables the final package to stand up by itself when placed on a flat surface.

B. Vertical Form/Fill/Seal (VFFS)

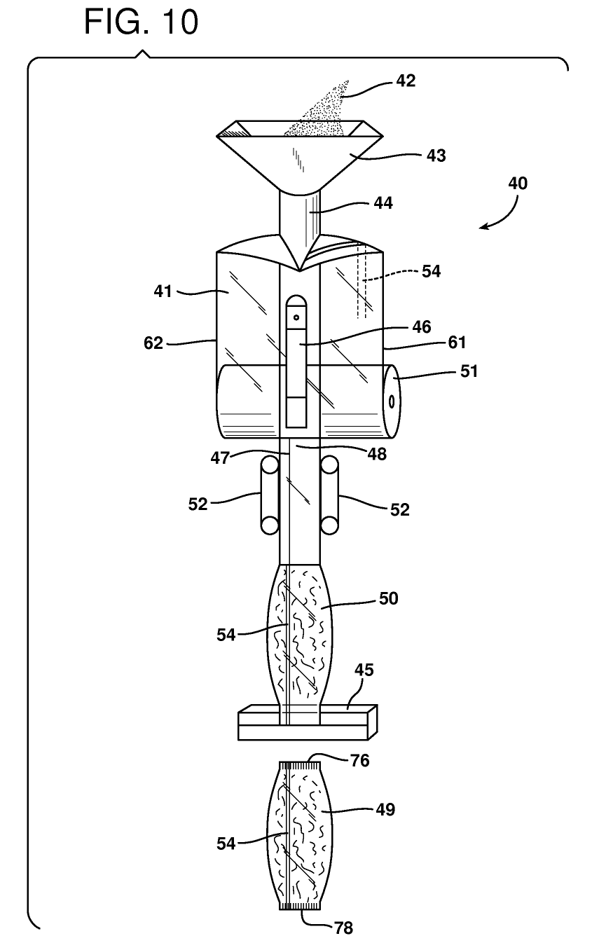

FIG. 10 illustrates a VFFS apparatus that can be used in conjunction with the apparatus and process according to some embodiments of the present invention. VFFS packaging systems are generally well known to those of skill in the art, and described for example in U.S. Pat. Nos. 4,589,247 (Tsuruta et al), 4,656,818 (Shimoyama et al.), 4,768,411 (Su), and 4,808,010 (Vogan), all incorporated herein by reference in their entirety.

A VFFS process and apparatus 40 is shown. Apparatus 40 uses lay-flat web 41 as a rollstock. Product 42 is manually or mechanically supplied to apparatus 40 from a source (not illustrated), from which a predetermined quantity of product 42 reaches the upper end portion of forming tube 44 via funnel 43, or other conventional means. The packages are formed in a lower portion of apparatus 40, and web 41 from which the packages are formed is fed from feed roll 51 over certain forming bars (not illustrated), is wrapped about forming tube 44 (sometimes known as a “sailor's collar” or “forming collar”) and is provided with a longitudinal fin seal or lap seal 47 by longitudinal heat sealing device 46, resulting in the formation of a vertically-oriented folded web in the form of a tube 48. Transverse heat seal bars 45 operate to close and seal horizontally across the lower end of vertically-sealed tube 48, to form a pouch 50 which is thereafter immediately packed with product 42. Film drive belts 52, powered and directed by rollers, as illustrated, or by suitable alternative motive means, advance tube 48 and pouch 50 a predetermined distance, after which end seal bars 45 close and simultaneously seal horizontally across the lower end of vertically-sealed tube 48 as well as simultaneously sealing horizontally across upper end of sealed pouch 49, to form a product packaged in sealed pouch 49. The next pouch 50, thereabove, is then filled with a metered quantity of product 42, forwarded, and the packaging cycle is repeated. It is conventional to incorporate with the end seal bars a cut-off knife (not shown) which operates to sever a lower sealed pouch 49 from the bottom of upstream pouch 50.

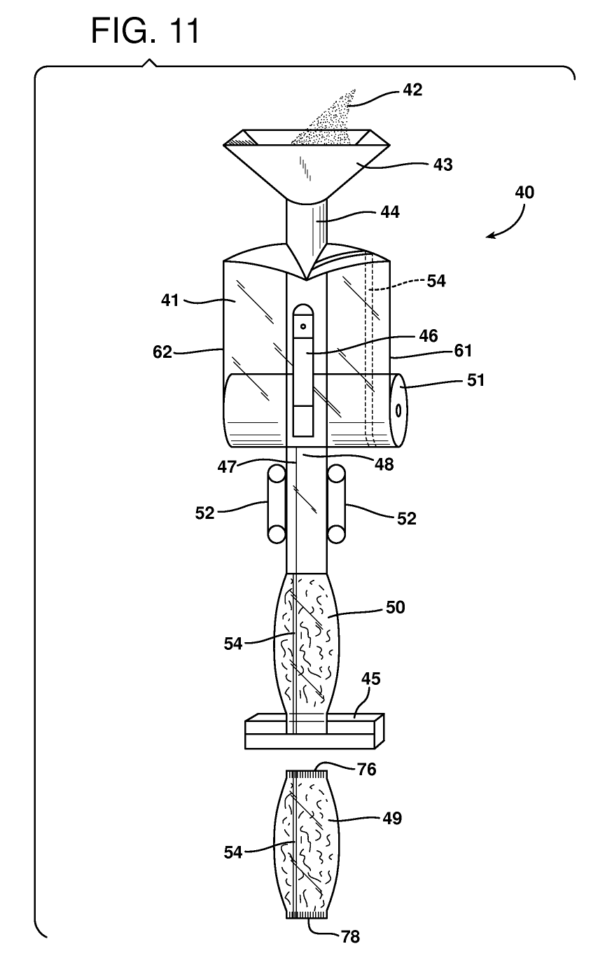

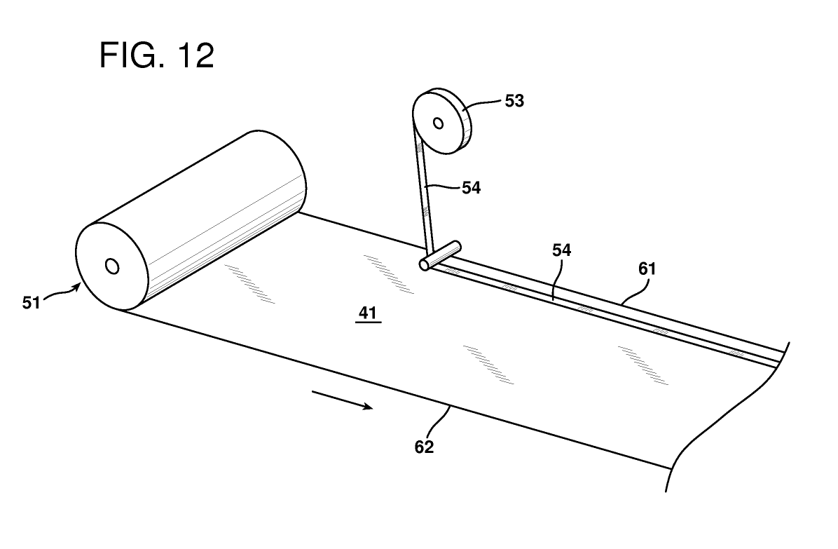

Lay-flat web 41 of FIGS. 10 and 11 typically travels vertically upward from roll 51 to forming tube 44, and then vertically downward for the remaining process steps. Strip 54 is unwound from roll 53 (see FIG. 12) so as to dispose strip 54 onto web 41 before, or as, web 41 is wrapped about forming tube 44, such that strip 54 is trapped between inner surfaces of the web 41 in the region where the longitudinal fin seal 47 is to be made. The fin seal 47 is made, and strip 54 is sealed to the inner surface of the formed web.

FIG. 12 discloses roll 51 of lay-flat web 41 in one embodiment. Strip 54 is fed from roll 53 onto lay-flat web 41, strip 54 disposed on web 41 near and spaced apart from, and parallel to, first longitudinal edge 61 of lay-flat web 41, and spaced apart from, and parallel to, second longitudinal edge 62.

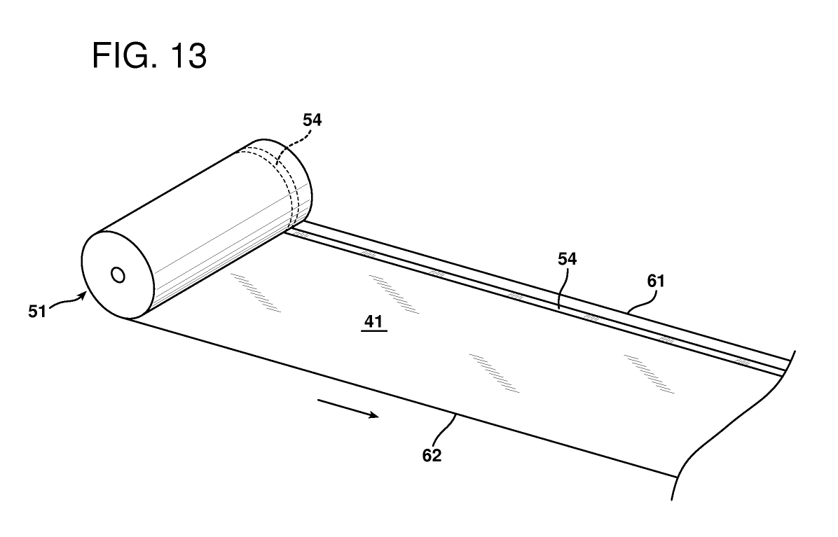

Alternatively (FIGS. 11 and 13) strip 54 is already installed on the lay-flat web prior to the start of the VFFS packaging process. This can be accomplished off-site from the processor, e.g. by the supplier of feed roll 51, but with the same disadvantage discussed for the embodiment of FIG. 9.

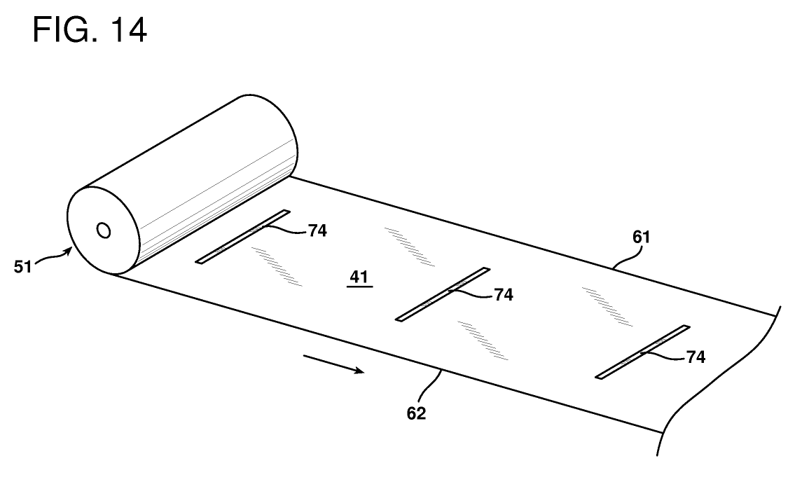

Alternatively (FIG. 14) strip 74 is pre-installed on the lay-flat web as in FIGS. 11 and 13, but the disadvantage associated with the embodiments of FIGS. 9 and 13 is avoided or minimized by spacing the consecutive strips 74 such that they are staggered as installed in winds on the roll 51 in a manner that avoids or minimizes roll asymmetry. Strips 74 are disposed on web 41 spaced apart from, and perpendicular to, first longitudinal edge 62.

In some embodiments, e.g. FIG. 14, at least one of the web and the discrete strip carries a registration device. Registration marks are printed or placed in uniformly spaced fashion e.g. along or near an edge of the web or strip, and facilitate the controlled production of packages of the invention.

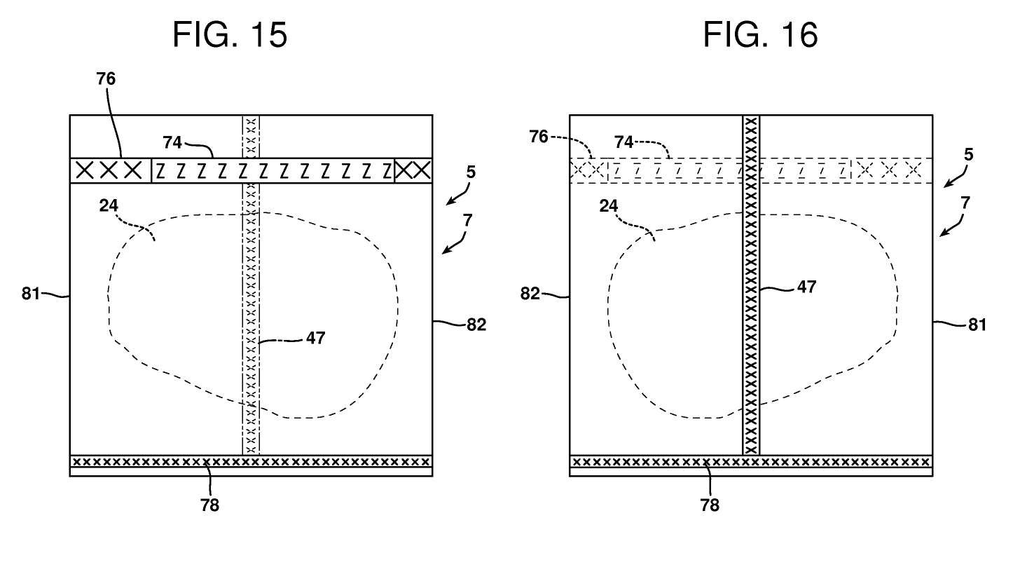

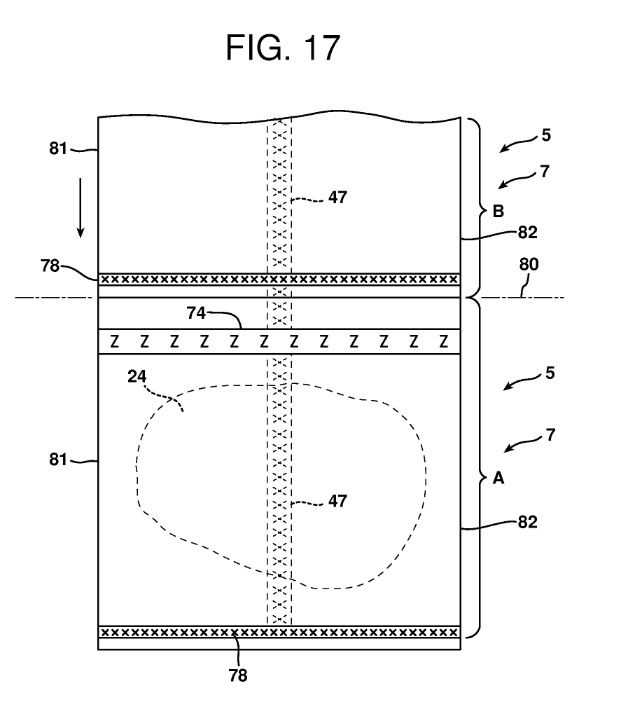

FIG. 15 shows a front view of a VFFS package 5 made in accordance with FIG. 14, and including a pouch 7 comprising first and second transverse seals 76 and 78, folded side edges 81 and 82, strip 74, longitudinal fin seal 47; and product 24. strip 74 is sealed to the interior surface of the pouch, and specifically to the front and back panels of the pouch in the area of transverse seal 76. FIG. 16 shows a back view of a VFFS package 5 made in accordance with FIG. 14, and including pouch 7 comprising first and second transverse seals 76 and 78, folded side edges 81 and 82, strip 74, longitudinal fin seal 47; and product 24. Strip 74 of FIGS. 15 and 16 does not extend entirely across the transverse width of pouch 7. In other embodiments, e.g. FIG. 17 through 19, strip 74 can extend entirely across the transverse width of, or across selected segments of, pouch 7. In FIG. 18, strip 74 is relatively small, and centrally located within the region of seal 78. This provides easy-open access to pouch “A” through a relatively narrow opening defined by strip 74. In FIG. 19, strip 74 is relatively small, and of a generally square shape, and located within the region of seal 78 at a horizontally terminal location. This provides easy-open access to pouch “A” through a relatively narrow opening defined by strip 74, such that the opening will function like a pour spout.

FIG. 17 is an elevational view of two consecutive pouches in a VFFS embodiment of the invention. A leading or downstream pouch “A” includes transverse bottom seal 78, folded side edges 81 and 82, strip 74, longitudinal fin seal 47; product 24 is disposed in the pouch. Trailing or upstream pouch “B” also has similar features to leading pouch “A”. Leading pouch “A” is severed from trailing pouch “B” at cut line 80, and seals 78, as well as the seal that adheres strip 74 to the inner surfaces of the side panels of the pouch, are made by suitable sealing equipment commonly used in VFFS packaging processes, such as heat sealing equipment, not shown.

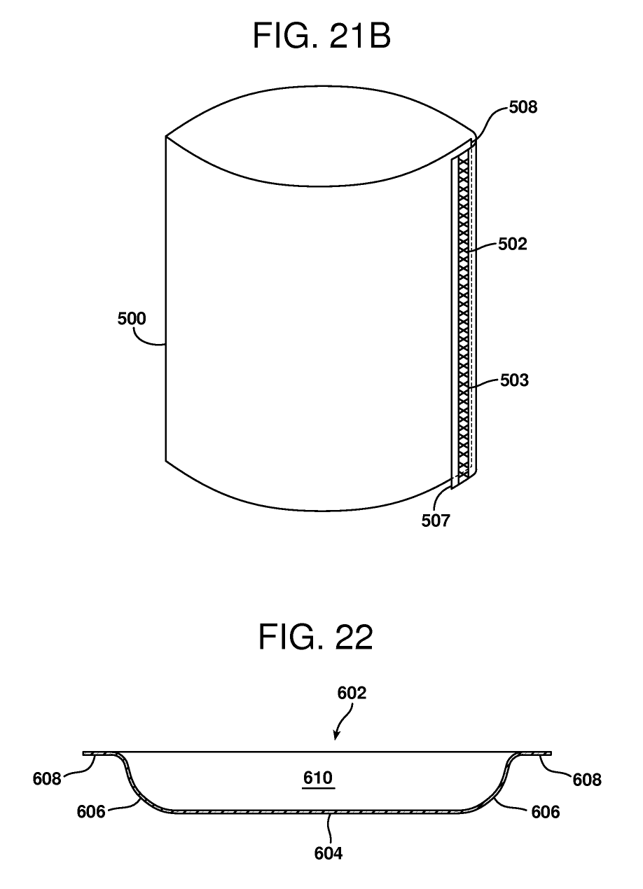

For the embodiments of FIGS. 15 through 17, it is necessary to limit any transverse heat seals to the portion of the package at which the strip is disposed. If the panels of the web material are sealed together in areas longitudinally beyond this portion, the package can be undesirably permanently sealed together, such that the easy-open functionality of the invention is not achieved. To assure this, in one embodiment the cut line 80 is vertically spaced apart from bottom seal 78 of following pouch “B” (see FIG. 17) such that some unsealed material is present at the very bottom of pouch “B” when a cut is made along cut line 80 to separate filled pouch “A” from pouch “B”. This assures that no part of seal 78 is present at the top of lead pouch “A”, such that it would prevent easy access to pouch “A”. Although the above limitations are true with respect to permanent seals (seals with a peel force of typically greater than 5 pli) that extend longitudinally beyond the discrete strip, it is demonstrated in FIGS. 15, 16, 18, and 19 that a heat seal of a permanent nature (>3 pli) can be made laterally adjacent an easy-open seal (i.e. the portion of the pouch occupied by the discrete strip). Of course, easy-open access to the package (the ability to manually open the package under normal conditions) is proportionate to that part of the package occupied by the discrete strip. Thus, a small discrete strip, (FIG. 19) permits only a small easy-open access opening, functioning effectively as a pour spout. The remainder of that area of the pouch, occupied by seal 78, will remain intact and unopened while access through the easy-open seal of strip 74 is provided. Regardless of the particular package format or process for making the package, the strip is sealed to and between webs or panels of the pouch or package in such a way that a high strength seal between web materials is not directly made, outside the bounds of the discrete strip, that would frustrate the easy open functionality of the strip. For example, in FIG. 21A, the longitudinal seal is made only within the area of the webs occupied by the discrete strip.

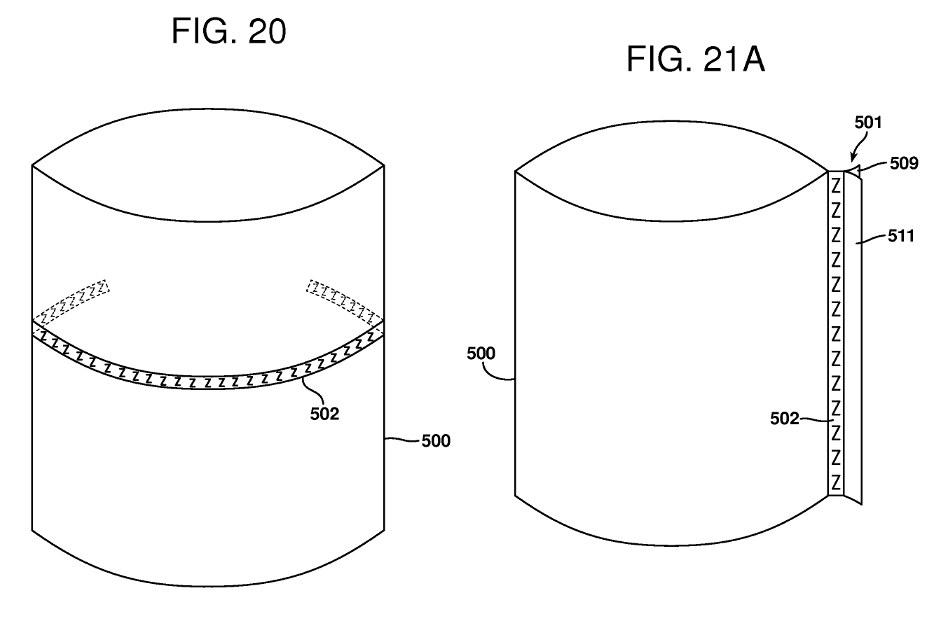

FIG. 20 shows a simplified perspective of folded web 500 in which strip 502 spans one entire side panel, as well as a portion of the other side panel of the folded tube. Although not shown, the remainder of the tube when made into a finished package includes a heat sealed portion between the two terminal points of the discrete strip to insure initial hermeticity of the package. Thus, the discrete strip of the invention can occupy one side panel of a package, and part of a second side panel of the package.

FIG. 21A shows a simplified perspective of folded web 500 in which strip 502 is disposed between and sealed to a longitudinal portion of the folded web, and is positioned within fin seal 501 of the folded web. Opening flaps 509 and 511 are disposed outside fin seal 501. These opening flaps can be used to open a package made from the folded web. A finished package made in accordance with FIG. 21A will thus look like the packages of FIGS. 3 and 4, when viewed at right angles to their position in FIGS. 3 and 4, i.e. with the strip 10 to the right side of each package, and the second end 34 representing a fold. In these embodiments, the fin seal 501 is located in, and limited to, the area occupied by strip 10. Effectively, at least part of the discrete strip 502 functions as part of the fin seal.

Alternatively in the embodiment of FIG. 21B, lap seal 503 is shown, wherein discrete strip 502 is disposed between and sealed to a longitudinal portion of the folded web, near a first longitudinal edge of the folded web, and is positioned within lap seal 503 of the folded web. The folded web of FIG. 21B is shown in a slightly open condition to clarify the features of this embodiment of the invention.

In this as well as the other processes disclosed herein, a lap seal can be used in lieu of a fin seal when making a longitudinal seal.

With a fin seal, two open flaps are formed representing the portion of each panel between the fin seal and the nearest longitudinal edge (the first end) of the package. These two flaps can be used to open the package by manually gripping a flap in each hand and pulling apart the package, utilizing the functionality of the discrete strip. The strip is disposed between, or sandwiched, in sealing relationship to the two respective inner surfaces of the web, thus effectively becoming part of the fin seal. With a lap seal, on the other hand, one opening flap 507 is available, i.e. the longitudinal edge portion of the folded web on the outside of the pouch when the package is completed. Flap 507 is thus defined by the region bounded by the first longitudinal edge of the folded web (the edge on the outer surface of the finished package). To open the package, one pulls back on flap 507, while holding the portion of the package opposite flap 507. A finished package in accordance with FIG. 21B will have a product therein; the two longitudinal ends of the package are closed by a transverse seal, e.g. a heat seal; and the lap seal, with the discrete strip therein, will run down the middle or spine of the package, bounded on both ends by the transverse seals.

The embodiment of FIG. 21A thus provides a method of producing packages on a VFFS apparatus where the lap or fin seal that forms the longitudinal seal of the package is near the first end of the finished packages and the access point to the discrete strip. The apparatus and methodology of U.S. Pat. No. 6,293,073 (Caudle) this patent incorporated herein by reference in its entirety, can be utilized in combination with the teachings herein, to produce packages in accordance with this embodiment. A point of distinction is that In the present invention, the transverse seals will typically (although not necessarily) be rectilinear, whereas the transverse seals disclosed in Caudle '073 are wavy or sinusoidal.

C. Lidstock/Formed Web

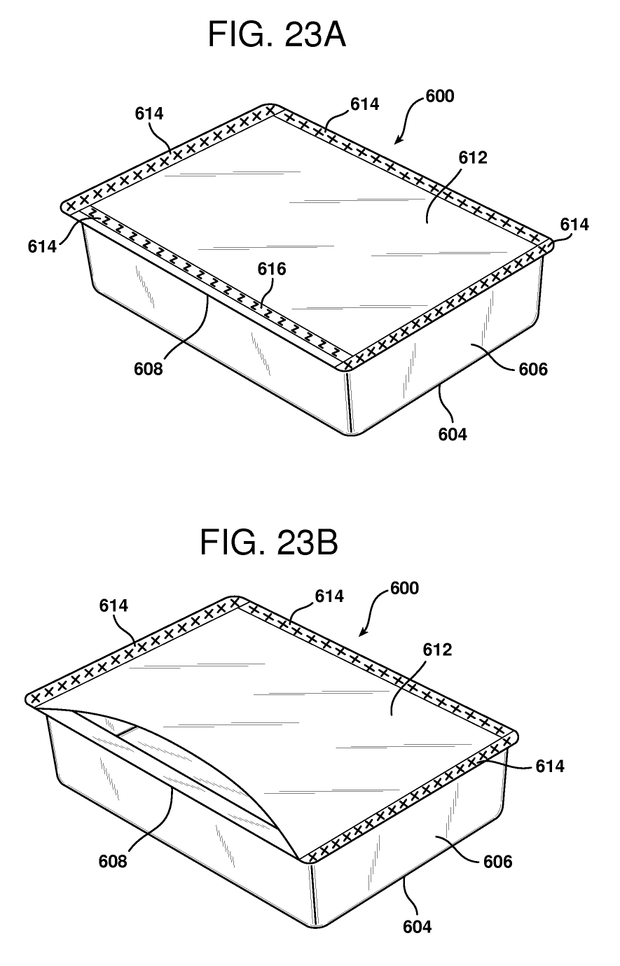

FIGS. 22, 23A, and 23B illustrate in another embodiment the use of a formed web, e.g. a tray, and a non-formed web, e.g. a lidstock, to be used in connection with the invention. Tray 602 will typically be made during the packaging process. Thermoforming equipment is used to convert flat thermoplastic forming web into formed pockets to create trays for containing the food product. Each tray 602 has tray bottom 604, tray sides 606, and tray flange 608 along its perimeter to which the printed lidstock laminate can be sealed by heat or other means. The tray bottom 604 and tray sides 606 define a tray cavity 610. Prior to any thermoforming step, tray 602 can be of any suitable thickness, e.g. from 2 to 30 mils thick, and any suitable construction.

If a pre-made tray is used in accordance with the invention, it can be rigid or semi-rigid, can be in the form of a flat or shaped tray, and can be made from any suitable material, including solid or expanded embodiments, such as polypropylene, polystyrene, polyamide, 1,4-polymethylpentene (e.g. TPX™ available from Mitsui), or crystallized polyethylene terephthalate (CPET). A tray liner can optionally be used, that adheres to the surface of the pre-made tray on which the food product is to be placed. This liner can be of any suitable design, and can be a multi-layer structure with at least one layer with gas-barrier properties. Such a liner can be adhered to the tray by heat lamination, extrusion lamination, extrusion coating, adhesives, corona treatment, etc. Tray 602 can be a flexible or semi-rigid, or rigid formed web.

A package includes tray 602 to which lidstock 612 has been sealed with a perimeter seal 614. Lidstock 612 is typically a lay-flat web formulated to function as a lid on a formed web, and can be any suitable monolayer or multilayer thermoplastic film as described herein with respect to webs useful in connection with the present invention. Lidstock 612 includes a discrete strip 616 having an easy-open sealant on one surface thereof, and a sealant on a second surface thereof. Strip 616 has the easy-open characteristics and composition discussed herein with respect to HFFS or VFFS packages. Thus, when lidstock 612 is pulled back from the tray flange 608 in the direction of the arrow, strip 616 will release from tray flange 608 so that the package is easily opened in the area of strip 616. A high strength (permanent) seal with a peel force of greater than 3 pli will hold down the corners of the package at each end of strip 616, such that the package will open as shown in FIG. 23B.

The lidstock can be sealed to the tray by conventional means, e.g. by a perimeter heat seal, but additionally strip 616 is disposed between the lidstock and the tray flange such that the discrete strip is trapped between and sealed to the lidstock and tray flange.

If the discrete strip is positioned, before the package is closed, so that the surface of the discrete strip comprising the easy-open sealant faces and is ultimately sealed to the tray flange, then upon opening the package, the discrete strip will release from the tray flange and remain adhered to the lidstock. Conversely, if the discrete strip is positioned, before the package is closed, so that the surface of the discrete strip comprising the easy-open sealant faces and is ultimately sealed to the lidstock, then upon opening the package, the discrete strip will release from the lidstock and remain adhered to the tray flange.

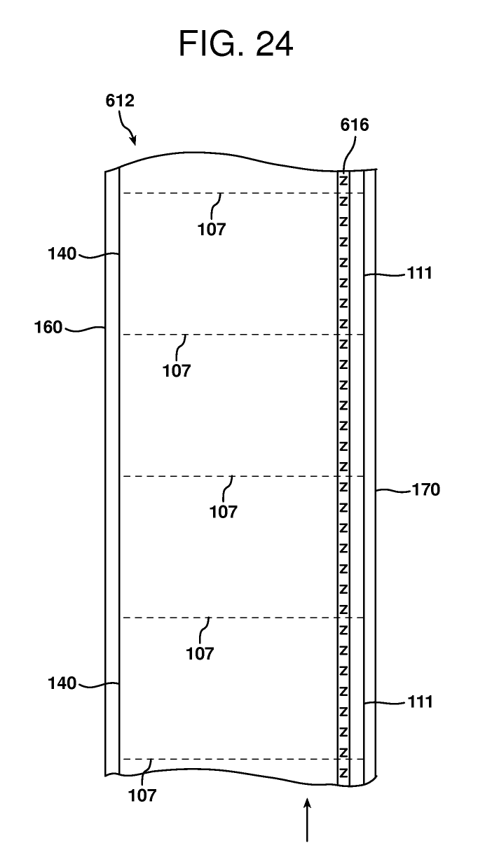

Referring to FIG. 24, a top plan view of the lidstock shows dotted lines 107 indicating the location at which lidstock 612 is sealed and cut, e.g. perimeter heat sealed and cut, in registered fashion by otherwise conventional means as discussed herein, e.g. in thermoforming equipment, to create individual packages. Thus, lines 107 represent what will become the side edges and seals of individual packages when the lidstock 612 is advanced into a packaging system where it is progressively fed over filled trays, sealed to the trays, and cut to create finished packages. Line 140 represents what will become the second end of individual packages. Line 111 represents what will become the first end of individual packages. Lidstock 612, as rolled up, and as it feeds into thermoforming equipment in an otherwise conventional packaging operation, will have a second lateral edge 160 and first lateral edge 170. During the sealing and cutting operation to make individual, filled packages, the web is cut such that the lidstock material between lines 170 and 111, and between lines 160 and 140, is removed as scrap.

Any suitable thermoforming machines, such as those available from Multivac, Tiromat, Ulma or Rapid Pak, can be used in accordance with the invention for packaging of food products, various industrial and consumer products and sterile medical products. Trays are formed from a lower web by heat and pressure, and can be loaded with product manually or automatically on the machine. After that, the packages are vacuumized or backflushed with modified atmosphere (if required), hermetically sealed to an upper web, separated, and removed for distribution or storage. Alternatively, pre-formed trays can be used.

FIG. 24 shows discrete strip 616 disposed on lidstock 612 near, parallel to, and spaced apart from, line 111. Strip 616 can be preinstalled on lidstock 612 by the supplier of the lidstock, as in the embodiments of FIGS. 9, 11 and 13. Alternatively, strip 616 can be installed on the lidstock during the packaging process, as in the embodiments of FIGS. 8, 10, and 12.

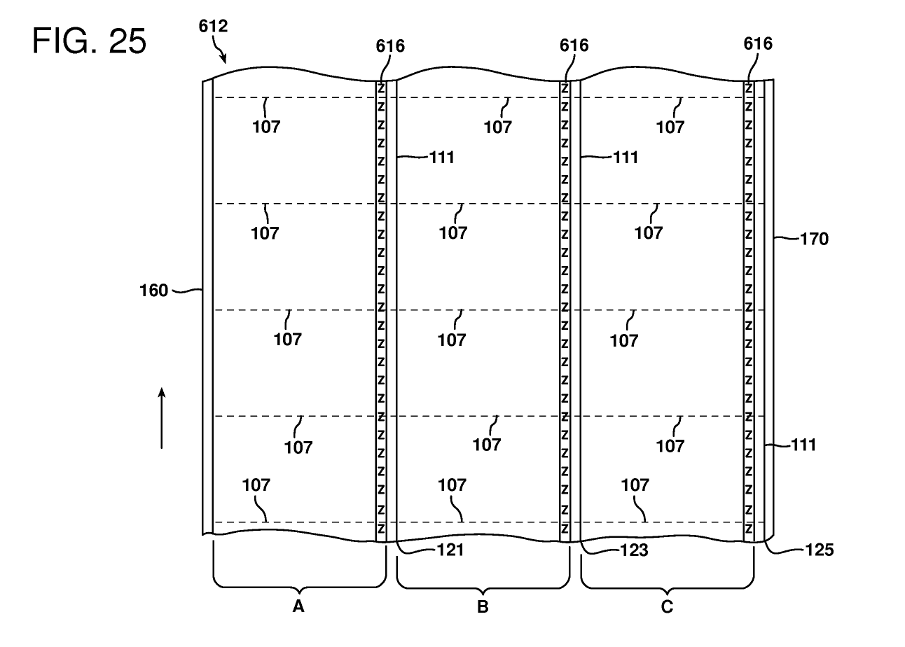

FIG. 25 shows an alternative in which the lidstock is produced as described above, but “three across”, so that when run in a packaging machine, with suitable machine die set-ups, three, six, etc. packages can be made simultaneously. In addition to the seal and cut steps at locations 107, the web is cut longitudinally along lines 121, 123, and 125 respectively, so that individual packages made from the longitudinal portion “A” of FIG. 25 have a first end 121; individual packages made from the longitudinal portion “B” of FIG. 25 have a first end 123; and individual packages made from the longitudinal portion “C” of FIG. 25 have a first end 125.

In another embodiment, the discrete strip can be positioned at right angles to the direction of travel of web 612, and can be preapplied to the web, as in FIG. 14.

D. Continuous Horizontal Packaging

The package of the invention can be made using a continuous horizontal form/fill/seal process and apparatus such as those used for packaging bakery and other goods. Such process and apparatus systems are sometimes known under variant terms such as Flow Wrap, Flow-Wrap or Flow wrapping machines or systems, and are available from manufacturers/suppliers such as Ilapak, ULMA, and Bosch.

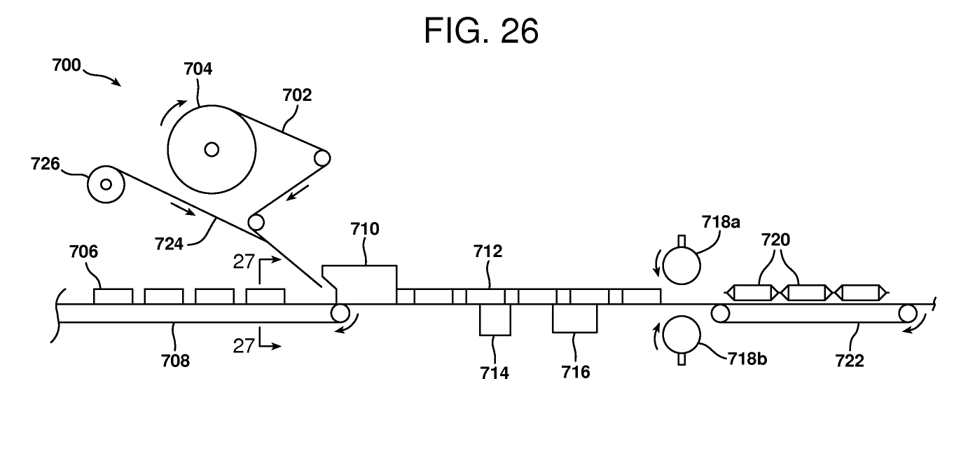

FIG. 26 shows such a process and apparatus 700, but one in which discrete strip 724 is installed into a package to produce a package of the invention. Lay-flat web 702 is drawn from roll 704 and advanced to forming device 710. As this occurs, a series of products 706 is advanced along conveyor 708 to forming device 710, and strip 724 is drawn from roll 726 and advanced to forming device 710. Web 702 is formed by forming device 710 into folded web 712. This folded web is like the folded web described above with respect to VFFS embodiments, but in a substantially horizontal orientation. Folded web 712 wraps around products 706. A longitudinal sealing device that can be part of forming device 710 forms a lap or fin seal (of the type disclosed above with respect to VFFS embodiments) typically at the bottom of the folded web. The lap or fin seal is typically a heat seal. An alternative is to have a separate sealing device 714 to produce the lap or fin seal. The products travel downstream from the forming device 710 and sealing device 714 to transverse sealing device 716 where the tube is transversely sealed in areas of the tube between adjacent products. Such seals are typically heat seals. The products are advanced from device 716 to cutting device 718a and 718b, where the formed and longitudinally and transversely sealed tube is severed in areas of the tube between adjacent products, in or near the transverse seals, such that individual packages 720 are produced.

The sealing function of transverse sealing device 716 and the cutting function of cutting device 718a and 718b can be combined at a single station, rather than being performed at separate locations on the production path.

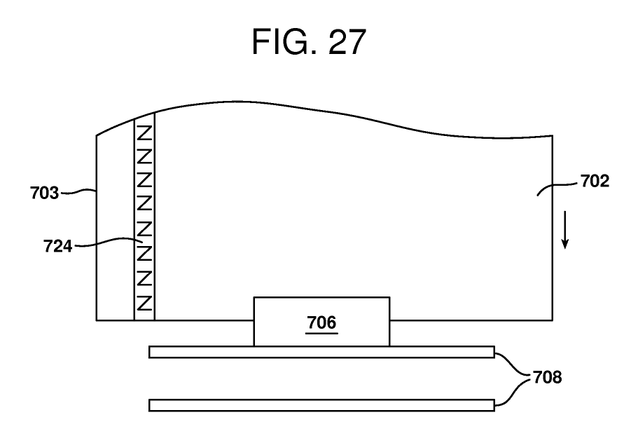

Web 702 and strip 724 can be of any suitable dimension and composition, such as those disclosed herein. As strip 724 is fed to forming device 710, it can be brought into contact with, and optionally adhered or sealed to a surface of web 702. This embodiment is shown in FIGS. 26 and 27, where strip 724 is shown as adhered or sealed parallel to, spaced apart from, and near a longitudinal edge 703 of web 702 as it progresses toward forming device 710. Alternatively, strip 724 can be fed into forming device 710, and then incorporated into the folded web 712 by adhering or sealing the strip to the interior surface of the web in the area of the formed web in which the lap or fin seal is made, and in a manner and format analogous to the embodiment of the VFFS pouch and package of FIGS. 10 and 21, but in a horizontal rather than vertical position. Strip 724 can be pre-applied to web 702 by the supplier of the web material, analogous to the embodiment of the VFFS pouch and package of FIG. 13, and the HFFS pouch and process of FIG. 9.

The discrete strip can be positioned at right angles to the direction of travel of web 702, and can be preapplied to the web, as in FIG. 14. The resulting packages will in this particular embodiment be like those illustrated in FIGS. 15 and 16.

E. Side Seal Bags

In one embodiment, the package of the invention can be made using otherwise conventional bag making equipment and processes. Bags are often made as side seal bags. The side seal bag has a factory-made heat seal at opposite bag edges. The bag bottom is formed by one of two folds of film created during the extrusion of bag tubing during manufacture. The opposite fold of film is slit to form a bag mouth. The bag is typically made from a long length of bag tubing. A method of making side seal bags is disclosed in US 2008/0138478 A1 (Ebner et al.), this patent incorporated herein by reference in its entirety.

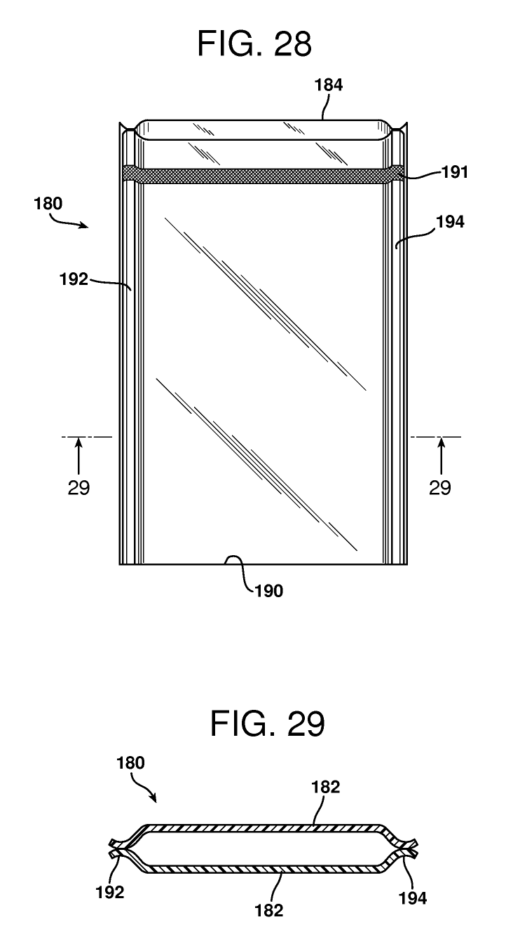

FIGS. 28 and 29 illustrate bag 180. FIG. 28 illustrates a side seal bag 180, in a lay-flat view; FIG. 29 illustrates a cross-sectional view taken through section 15-15 of FIG. 28. With reference to FIGS. 28 and 29 together, side seal bag 180 comprises a web 182, first edge 184 defining an open mouth, edge fold 190, first side seal 192, and second side seal 194. A discrete strip is installed on the individual bag, or on a slit bag tube that is then cut and sealed at predetermined intervals to make a series of side seal bags 180, by any suitable process such as any of those disclosed herein.

A bag with a discrete strip disposed thereon can be made by extruding a thermoplastic tube to make a bag tubing; slitting the tubing at one longitudinal edge thereof; and periodically transversely cutting and sealing the bag tubing to make a plurality of individual bags each with a discrete strip disposed thereon. The discrete strip can function as described herein for other embodiments and processes, in providing an easy-open package. Some of the steps set out in US 2008/0138478 A1, for making a bag, are optional with respect to the present invention; such steps including irradiation and orientation of the tubing.

The above descriptions are those of embodiments of the invention. All parts and percentages are by weight, unless otherwise indicated or well understood in the art. Except in the claims and the specific examples, or where otherwise expressly indicated, all numerical quantities in this description indicating amounts of material, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. All references to ASTM tests are to the most recent, currently approved, and published version of the ASTM test identified, as of the priority filing date of this application. Each such published ASTM test method is incorporated herein in its entirety by reference.

Terms referring to polymers, such as polyester, polyamide, and polyolefin, refer herein to both homopolymers and copolymers thereof, unless otherwise specified.

With reference to the drawings, the flow of materials is in the direction of the arrows.

Those of skill in the art will recognize that the drawings herein are not necessarily to scale, and certain features of the invention may be graphically exaggerated for clarity.

Both the web or webs used in the manufacture of the package in accordance with the invention, and the discrete strip of the invention, can be made by any suitable process, including coextrusion, extrusion coating, extrusion lamination, and conventional lamination using polyurethane or other adhesives. These manufacturing processes are well known in the art. Extrusion can be done in annular or flat dies. The extrudate can be hot blown or cast, and optionally solid-state oriented as desired. Chemical or electronic crosslinking of one or more layers of the webs or the strip can be done. Both web and strip can be advanced by suitable motive means (not shown, and well known in the art, such as a motor) from their respective rolls.

A package in accordance with the invention can optionally carry printed indicia, which can be decorative or informational in nature. Decorative printed indicia can include a logo, a trademark, product information, etc. with text and/or graphics.

Printed indicia can be in the form of a message (e.g. “easy open” or “open here”. This can be printed in scattered process (i.e. registration is not required) on or near the first end of the package. The message is surface printed or reverse printed.

In some embodiments, such as those shown in FIGS. 8 to 14, it may be beneficial to adhere the discrete strip to the lay-flat web prior to processing on equipment, or at the time, before processing, when the strip is disposed on the web. Any suitable means, such as permanent adhesive or heat sealing, can be used to seal the strip to the web to ensure that the strip maintains its position on the web during processing. In these embodiments, the strip is adhered or sealed to the web at the interface between the web and the surface of the strip comprising a sealant layer that provides a relatively strong seal. The strip can be e.g. sealed to the web by a suitable device (not shown) such as a heat sealer, disposed below the web (see FIGS. 8 and 12) while the web is in its lay-flat condition, that seals the strip to the web. In such embodiments, the surface of the discrete strip that comprises the easy-open surface faces away from the web, so that the opposite surface of the discrete strip is sealed to the web. This approach leaves the easy-open surface unaffected until such time as the package is made and closed, or until e.g. the lap or fin seal is made on the pouch.

The present invention, including the packages and methods as disclosed herein, is provided in the absence of: plastic zipper closures; press-to-close or slide zippers; interlocking closures; reclosable fasteners with interlockable fastener elements; interlocking rib and groove elements having male and female profiles; interlocking alternating hook-shaped closure members, and the like. None of these aforementioned closures or systems is present in the packages or processes of the invention.

Although the invention is described in some embodiments herein as a package comprising a thermoplastic pouch comprising a first and second side panel each having a first end, a first transverse edge, and a second transverse edge, those skilled in the art will understand, after a review of this disclosure, that in some embodiments, wherein a single web is used, the terms “side panel”, “first end”, “first transverse edge”, “second transverse edge”, and the like are used for convenience to describe the relative locations or regions on a single web made into a pouch, so that the overall geometry of the package, and relative positions of the various features of the invention can be described. Thus, for instance, the first and second panels in a single web embodiment of the invention can be simply defined regions of the pouch, and the package made therefrom, and transverse edges are simply the transverse end lines of those regions. In such embodiments, the line of joinder of the transverse edges are the two side folds in the web that define the sides of the package. In contrast, in embodiments with two webs, each web when produced will have an identifiable first and second transverse edge, that will each be joined to a respective transverse edge of a second web.

Those skilled in the art will appreciate, after a review of this disclosure, that in embodiments of the invention where two opening flaps are employed (e.g. FIGS. 1 and 2, 15, and 21A), the two opening flaps should be sufficiently long, and/or the discrete strip sufficiently short, that in opening the package, the user grasps only the two flaps, and not the discrete strip. In the event that the discrete strip is grasped, in some cases the package will not open easily.

The two opening flaps can comprise the first end of the package of the invention, the two flaps unattached at their first ends. Alternatively, the first end of the two flaps can be sealed together (the remainder of the two flaps remaining unsealed), and a perforation line installed in the first and second side panel, near the first end of the package (see e.g. FIG. 8B. In use, the end of the package is torn off, exposing the first and second opening flaps. These flaps are then pulled apart to access the package contents by breaking the easy-open seal, as described herein.

What is claimed is:

1. An easy-open package comprising:
a) a pouch comprising
i) a first and second side panel each comprising an outer and inner surface, a first and second side edge, and a first and second end, the first and second side panels joined together along their respective first and second side edges;
ii) a first end defined by the first end of at least one of the first and second side panels respectively;
iii) a second end defined by the second ends of the first and second side panels respectively;
iv) the first and second side panels joined together along their respective second ends;
v) a discrete strip disposed between the first and second side panels, the discrete strip comprising a first and second surface, wherein
(a) the first and second surface each comprises a sealant,
(b) at least one of the first and second surfaces comprises an easy-open sealant,
(c) the first surface is sealed to the inner surface of the first side panel,
(d) the second surface is sealed to the inner surface of the second side panel, and
(e) the discrete strip is near and spaced apart from the first end of the pouch, and spaced apart from the second end of the pouch;
vi) a first opening flap comprising a portion of the first side panel between the discrete strip and the first end of the first side panel, and
vii) a second opening flap comprising a portion of the second side panel between the discrete strip and the first end of the second side panel; and
b) a product disposed in the pouch.

2. The package of claim 1 wherein the first and second side panels are joined together along their respective first and second side edges by a seal.

3. The package of claim 1 wherein the first and second side panels are joined together along their respective first and second side edges by a fold.

4. The package of claim 1 wherein the second end of the first side panel, and the second end of the second side panel, are joined together by a seal.

5. The package of claim 1 wherein the second end of the first side panel, and the second end of the second side panel, are joined together by a fold.

6. The package of claim 1 wherein the discrete strip is disposed perpendicular to the first and second side edges of the first and second side panel respectively.

7. The package of claim 1 wherein the package can be opened with a peel force of from 25 grams/inch to 5 pounds/inch.

8. A method of making an easy-open package in a horizontal form/fill/seal process comprising:
a) providing a lay-flat web;
b) providing a discrete strip comprising a first and second surface each comprising a sealant, at least one of the first and second surfaces comprising an easy-open sealant;
c) advancing the lay-flat web to a forming device to convert the lay-flat web to a folded web having an interior surface;
d) advancing the discrete strip such that when the package is made, the discrete strip is disposed between a first and second side panel of the package;
e) making side seals in the folded web to produce an open pouch comprising
i) the first and second side panel each comprising an outer and inner surface, a first and second side edge, and a first and second end, the first and second side panels joined together along their respective first and second side edges by a seal,
ii) a first end defined by the first end of at least one of the first and second side panels respectively,
iii) a second end defined by the second ends of the of the first and second side panels respectively,
iv) the first and second side panels joined together along their respective second ends,
v) the discrete strip near and spaced apart from the first end of the pouch, and spaced apart from the second end of the pouch,
vi) a first opening flap comprising a portion of the first side panel between the discrete strip and the first end of the first side panel, and
vii) a second opening flap comprising a portion of the second side panel between the discrete strip and the first end of the second side panel;
f) putting a product in the open pouch; and
g) sealing the first surface of the discrete strip to the inner surface of the first side panel, and sealing the second surface of the discrete strip to the inner surface of the second side panel, to close the pouch;
wherein the web is cut at the side seals during the step of making side seals in the folded web, or during or after any subsequent step; and
wherein at any time before or during the step of making side seals in the folded web, anchoring the discrete strip to the lay-flat web, interior surface of the folded web, or inner surface of the first or second side panel.

9. The method of claim 8 wherein the discrete strip is advanced from a roll and applied to the lay-flat web prior to advancing the lay-flat web to the forming device.

10. The method of claim 8 wherein the second end of the first side panel, and the second end of the second side panel, are joined together by a seal.

11. The method of claim 8 wherein the second end of the first side panel, and the second end of the second side panel, are joined together by a fold.

12. The method of claim 8 wherein the discrete strip is disposed perpendicular to the first and second side edges of the first and second side panel respectively.

13. The method of claim 8 wherein the package can be opened with a peel force of from 25 grams/inch to 5 pounds/inch.

14. A pouch comprising
a) a first and second side panel each comprising an outer and inner surface, a first and second side edge, and a first and second end, the first and second side panels joined together along their respective first and second side edges;
b) a first end defined by the first end of at least one of the first and second side panels respectively;
c) a second end defined by the second ends of the first and second side panels respectively;
d) the first and second side panels joined together along their respective second ends;
e) a discrete strip disposed between the first and second side panels, the discrete strip comprising a first and second surface, wherein
(i) the first and second surface each comprises a sealant,
(ii) at least one of the first and second surfaces comprising an easy-open sealant;
(iii) the first surface is sealed to the inner surface of the first side panel, or the second surface is sealed to the inner surface of the second side panel, and
(iv) the discrete strip is near and spaced apart from the first end of the pouch, and spaced apart from the second end of the pouch;
f) a first opening flap comprising a portion of the first side panel between the discrete strip and the first end of the first side panel, and
g) a second opening flap comprising a portion of the second side panel between the discrete strip and the first end of the second side panel.

15. The pouch of claim 14 wherein the first and second side panels are joined together along their respective first and second transverse edges by a seal.

16. The pouch of claim 14 wherein the first and second side panels are joined together along their respective first and second side edges by a fold.

17. The pouch of claim 14 wherein the second end of the first side panel, and the second end of the second side panel, are joined together by a seal.

18. The pouch of claim 14 wherein the second end of the first side panel, and the second end of the second side panel, are joined together by a fold.

19. The pouch of claim 14 wherein the discrete strip is disposed perpendicular to the first and second side edges of the first and second side panel respectively.

20. The pouch of claim 14 wherein a package made from the pouch can be opened with a peel force of from 25 grams/inch to 5 pounds/inch.
